(19) United States
(12) Patent Application Publication
(10) Pub. No.: US 2021/0049441 A1
(43) Pub. Date: Feb. 18, 2021

(54) METHOD OF NEWS EVALUATION IN SOCIAL MEDIA NETWORKS

(71) Applicant: Twitter, Inc., San Francisco, CA (US)

(72) Inventor: Michael Bronstein, Cambridge, MA (US)

(21) Appl. No.: 15/733,639

(22) PCT Filed: Mar. 20, 2019
(86) PCT No.: PCT/US19/23119

§ 371 Date: Sep. 22, 2020

Related U.S. Application Data
(63) Continuation of application No. 15/982,609, filed on May 17, 2018.
(60) Provisional application No. 62/646,387, filed on Mar. 22, 2018.

(30) Foreign Application Priority Data
Feb. 1, 2019 (EP) 19155071.4

(51) Int. Cl. G06N 3/04; G06F 17/18; G06F 17/11; G06F 17/16; G06F 16/901

(52) U.S. Cl. CPC G06N 3/04; G06F 17/18; G06F 16/9024; G06F 17/16; G06F 17/11

(57) ABSTRACT

A method of news evaluation in social media networks having a plurality of socially related users, the method comprising the steps of determining a social graph at least with respect to users and their social relations; determining a news message to be evaluated; determining a propagation behaviour of the news message in the social graph; evaluating the news message in view of its determined propagation behaviour in the social graph.

The present invention relates to the communication of information.

It is well known that when communicating (or “propagating”) information, colliding interests may occur. On the one hand, it frequently is in the interest of a person, enterprise, public authority, political party asf, to distribute certain information such as news, advertisement, bulletins or warnings fast to a large number of people. This may help promote ones viewpoint, business or social status. On the other hand, people actually distributing the information may have an interest to ensure that information is distributed only when correct and/or in a manner not doing harm to them.

To propagate information, various ways are known, depending inter alia on the information propagated and the technical means available. Frequently, information is referred to as “news” or “news messages” in particular where the intended recipient is human, even though the information received may not be novel to the recipient.

In ancient times, prior to the development of advanced technologies, news messages were propagated from person to person, for example when a traveler after several years abroad returned from far away and gave account of what he had seen during his voyage. When doing so, it could not always be guaranteed that the account a traveler gave of his observations was correct, not at least because it was not uncommon to embellish the accounts given to make them more interesting. So, the recipient of the news had to judge themselves whether and to what degree the account was credible. As the amount of information propagated and received by each person was small, basically all news could to some extent be evaluated by a recipient in view of the credibility of both the person giving account and the credibility of the message itself. At least if both the person giving account and the message itself deemed credible, it was likely that such news message be propagated within the community of the recipient. In this manner, both personal information relating to single persons or small groups, for example relating to the health of a relative, and more publicly relevant information, for example relating to new laws, the intentions of a monarch asf. could be spread.

When it became possible to distribute information more efficiently, for example by printed “news” paper, radio or television, the number of news messages received by a single person significantly increased. A recipient thus could only evaluate the message in view of the overall credibility of the newspaper publisher or broadcast station—where news generally were received from credible news agency or employed reporters, selected as relevant and then double-checked before transmission. In this manner, distribution of news can be restricted to messages giving correct account of actual events as long as newspaper publishers or broadcast stations maintain a sufficiently high standard.

In the past decade, another way of propagating informations has emerged, namely social media networks such as Facebook. Twitter and the like. In such networks, new informations can be input by a user, often by way of sharing links, and shared with his “friends”, that is others the user is connected with. The amount of information newly entered is enormous, and where a user has a large number of friends, the user can both share information very fast with a large number of people and might receive information from a large number of people. This is already disadvantageous for at least two reasons, even where only true news are transferred. First, it is well known that the overall amount of information a person can process is limited, e.g. due to time restrictions. Then, transmitting a large number of messages to a person requires at least significant bandwidth.

Social media are even suspected to have become one of the main sources of information for people around the world. Yet, using social media for news consumption is a double-edged sword: on the one hand, it offers low cost, easy access, and rapid dissemination. On the other hand, it comes with the danger of exposure to “fake news” with intentionally false information.

This may have a significant social and economical impact as can be seen e.g. from the discussion relating to manipulations of the US 2016 presidential elections or the Brexit vote that at least by some is considered to have been due to or at least influenced by fake news. In this context, it is alleged that the outcome of these votes resulted from the public opinion manipulation by a massive injection of fake news, possibly produced by influence agents or even sponsored by hostile foreign governments. While hard to verify this allegations with certainty, the fallout of the fake news scandal in the American and British societies is very heavy, with some analysts going as far as declaring fake news among the most serious and unprecedented threats to the modern democracies.

The public opinion is therefore rethinking the responsibility of social networks such as Facebook or Twitter, which have thus far positioned themselves as mere media distribution platforms, essentially shaking off any liability for the published content. This stance is in clear contrast to the stance of conventional news distributors such as newspaper publishers, radio stations and so forth, and this stance is very likely to change in the near future, with eminent legislation in the USA that would hold social network companies accountable for the content published on their platforms.

Such regulation, if approved, should be expected to have a tremendous impact on Internet giants like Facebook, Google, or Twitter, as well as smaller media and advertisement companies relying on social network platforms. These companies are now in extreme need of technological solutions capable of combatting the fake news plague, and admit that existing technology is insufficient. Attempting to combat the fake news phenomenon and responding to the mounting public and political pressure, in March 2017 Facebook rolled out a content alert feature relying on users fact checking and flagging disputed content, which turned unsatisfactory and was taken down later that year. Applicant currently is not aware of any fully automatic commercial solution capable of reliably detecting fake news.

This holds, although filter algorithms are already used by social media networks that decide what messages should or should not be propagated to a user. However, these filters may rely on preferences of a user, previous “likes” expressing interest in certain previously received messages asf, so that basically a user receives messages he is supposed to appreciate rather than a message that is true.

In contrast, regarding the content of a message, it currently is still next to impossible to automatically determine whether a message is completely true or whether the message relates to alleged events that have not happened as reported. Such determination whether or not a message relates to true information or fake news is particularly difficult as a news message may have some truth in it, but may have been manipulated by omitting relevant true facts or by adding facts made up. This is particularly important in social media networks, because there, due to the extreme large number of users and messages, evaluation of the “truth” in a message by a group of responsible human operators is not considered economically feasible any longer.

Accordingly, when it comes to propagation of information in social media network, improvements are desirable, e.g. to make better use of technical resources available, to ensure that the time a user spents in the network is not wasted on fake news asf. For example, it might be desirable that the information a person receives is of a higher quality. Also, it might be desirable to prevent abuse of a communication system and the bandwidth available. Also, it might be desirable to improve propagation of certain information and/or to prevent propagation of other information. It might also be helpful to identify information as fake news and/or to determine whether propagation of information needs to prevented and/or promoted and/or to predict whether certain information should be expected to be widely spread or not.

In view of this, attempts have already been made to reduce the impact of fake news in social media. Several approaches have been suggested to this end. For example, efforts have been made to identify a pattern associable with fake news and usable in the identification thereof.

In S. Vosoughi et al, “The Spread of True And False News online”. Science 359, 1146/1151 (2018), it has been suggested that falsehood diffused significantly farther, faster, deeper and more broadly than the truth in all categories of information. The authors have suggested that false news are more novel than true news, which suggests that people were more likely to share novel information. The authors have emphasized that contrary to common belief, users who spread false news had significantly fewer followers, followed significantly fewer people, were significantly less active, (on Twitter), were verified significantly less often and had been on the Twitter social media network for significantly less time. Still, despite these differences, falsehood was stated to diffuse farther and faster than the truth, and the authors emphasize that false rumors inspired replies expressing greater surprise. It has also been emphasized that contrary to conventional wisdom, robots spread true and false news at the same rate, implying that false news spreads more than the truth because humans, not robots are more likely to spread it.

In a paper titled “Some like it Hoax: Automated Fake News Detection in Social Networks” by E. Tacchini et al, arXiv: 1704.07506v1 [cs.LG] 25 Apr. 2017, it was shown that Facebook posts can be classified with high accuracy as hoaxes or non-hoaxes on the basis of the user who “liked” them. It was emphasized that a significant share of hoaxes on social network sites diffuses rapidly with a peak in the first 2 hours highlighting the need of an automatic online hoax detection system. It was found that hoax posts on average have more likes than non-hoax posts. It was found that a high polarization exists with respect to likes. Among users with at least 2 likes, almost ¾ were reported to like hoax posts only, whereas about 20% liked non-hoax posts only with the remaining percentage of 5% liking both hoax and non-hoax posts. The authors speak of a high polarization. The authors cite that user tend to aggregate in communities of interest, which causes reinforcement and fosters confirmation bias, segregation, and polarization, and that “users mostly tend to select and share content according to a specific narrative and to ignore the rest”. The authors thus suggest to classify posts on the basis of which users liked them. The authors state one should rely on a learning set of posts for which the ground truth is known. They claim that using appropriate algorithms, identification of hoax could be obtained with a training set small compared to a full data set.

In “News Verification by Exploiting Conflicting Social Viewpoints in Microblogs” by Z. Jin et al., Proceedings of the Thirtieth AAAI Conference on Artificial Intelligence, it was suggested to improve news verification by mining conflicting viewpoints and microblogs. The authors note that it is important to detect fake news very early and emphasize that a detection delay time starting from the first tweet of news, only tweets posted no later than the delay time should be used for verification as giving early alerts of fake news could prevent further spreading of malicious content on social media.

In “Fake News Detection in Social Media: Data Mining Perspective” by Kai Shu et al., arXiv: 1708.01967v3 [cs.Sl] 3 Sep. 2017, it has been emphasized that in 2016 already 62% of US adults get news on social media, that fake news itself would not be a new problem since nations or groups have been using the news media to execute propaganda or influence operations for centuries: that fake news is usually related to newly emerging, time-critical events which may not have been properly verified by existing knowledge bases due to the lack of corroborating evidence or claims and that there are some emerging patterns that can be utilized for fake news detection in social media. The authors emphasize that humans are vulnerable to fake news because consumers tend to believe that their perceptions of reality are the only accurate views while others who disagree are regarded as uninformed, irrational or biased, and that the consumers preferred to receive information that confirms their existing views and that once the misperception is formed, it is very hard to correct. The authors allege that fake news pieces are likely to be created and spread by non-human accounts such asocial bots or cyberbots and that capturing user profiles and characteristics by user-based features could provide useful information for fake news detection using various aspects of user demographics such as registration age, number followers, followees, number of tweets the author has authored and so orth. They state that an extension of a friendship network indicating the following/followees structure of users who post related tweets would be the diffusion network which tracks the trajectory of the spread of news, where nodes represent the users and edges represent the information diffusion paths among them. The authors also emphasize that each feature basically usable in fake news detection such as source credibility, news content style or social response has some limitations to directly predict fake news on its own and that the diffusion of fake news and social media demonstrates its own characteristics that need further investigation such as social dimensions, lifecycle, spread information, identification and so forth. These authors suggest that studying the lifecycle of fake news might provide deeper understanding of how particular stories “go viral” from normal public discourse. Tracking the life cycle of fake news on social media is stated to require recording essential trajectories of fake news diffusion in general as well as investigation of the process for specific fake news pieces. The authors report that there is recent research that attempts to use content-based immunization and network-based immunization methods in misinformation intervention.

In “Detecting Hoaxes, Frauds, and Deception in Writing Style Online” by S. Afroz. M. Brennan and R. Greenstadt, it has been suggested that writing style is an important feature in fake news identification.

In “Prominent Features of Rumor Propagation in Online Social Media” by S. Kwon, M. Cha, k. Jung. W. Chen, and Y. Wang it was observed that when investigating temporal properties in rumor spreading, a distinct feature observed from time series is that rumors tend to have multiple and periodic spikes, whereas non-rumors typically have a single prominent spike. It was alleged that no parameter could explain the multiple spiky pattern of the rumor versus the single-peak pattern of non-rumors.

In the paper “CSI: A Hybrid Deep Model for Fake News Detection” by N. Ruchansky et al., arXiv: 1703.06959v4 {cs.LG} 3 September a model was proposed that combines 3 allegedly generally agreed upon characteristics of fake news, namely the text of an article, the user response it receives and the source user promoting it. These authors note that efforts to automate response detection typically model the spread of fake news as an epidemic on a social graph. It is quoted that the temporal pattern of user response to news articles plays an important role in understanding the properties of the content itself and that one popular approach has been to measure the response an article receives by studying its propagation on a social graph.

These authors suggest to capture the pattern of temporal engagement of users with an article (or news message) both in terms of the frequency and distribution stating that they wish to capture not only the number of users that engaged with a given article but also how the engagements were spaced over time. The feature vector capturing the temporal pattern of engagement an article receives with certain quantities, namely the number of engagements and the time between engagements, is stated to be simple yet powerful. The authors also incorporate the source by adding a user feature vector that is global and not specific to a given article. The authors note that while the feature vector associated with each engagement could be considered as an input into a cell, this would be highly inefficient for large data sets so that a more efficient approach would be to partition the feature vector and using an aggregate of each partition such as an average. The authors suggest to apply a natural partitioning by changing the temporal granularity from seconds to hours as treating each time stamp as its own input into a cell to be extremely inefficient and to reduce utility. These authors relate to an indication of the suspiciousness of a user and note that the lack in time between an article's publication and when the user first engages with it is similar on fake and true news for suspicious users on Twitter which the authors consider to demonstrate a sophistication in fake content promotion techniques.

As the above discussion shows, most current approaches for fake news detection can be divided into those making use of content features and social context features. Examples of content features, which are used in the majority of works in the domain of fake news detection, are linguistic (lexical and syntactic) features that can capture deceptive cues or writing styles. The main drawback of content-based approaches is that they can be easily defied by sufficiently sophisticated fake news that do not immediately look like fake. Furthermore, most linguistic features are language dependent, so that they are very hard to implement in a multinational social media network. So, while such method might work to some extent for those languages a large number of user use, e.g. English or Spanish, it is hard to implement filters for dialects or languages used by a rather small number of users, such as Icelandic.

On the other hand, additional features can be derived from the user-driven social engagements of news consumption in social networks. Social engagements may represent the news proliferation process over time, which might provide useful auxiliary information to infer the veracity of news articles. Social context features including user demographics (age, gender, education, etc.) user reactions (e.g. posts accompanying a news item) and the spread network structure (timed propagation of the news item in the social network). The latter type of features might have some theoretical importance in view of fake news dissemination processes that tend to form an ‘echo chamber cycle’ manifested in certain propagation patterns not at least due to algorithms of news propagation implemented by the site operator. Yet, approaches known by the applicant so far have only attempted applying features handcrafted to assumed graph-theoretical features such as centrality, cliques of connected components, which however are rather arbitrary and not necessarily meaningful for the specific task of fake news detection.

As can be seen above from the discussion of scientific papers examining fake news detection methods and news propagation in social networks, fake news detection in social media has recently attracted considerable attention in the academic realm; it is well known that also problems associated with fake news have gained considerable public attention. Yet, there is no clear agreement on patterns, user behavior, influence of bots asf.

Nonetheless, given the growing importance of social networks as source of news, and given the potential to abuse social networks for fake news propagation, it is desirable to have a method that allows fast classification of media. What is obvious is that while there is still a debate even about the problem definition (for example, what to consider as fake news), fake news detection poses challenges that defy existing approaches for media analysis and require different new methods. One of the main reason is believed to be that fake news are often intentionally written by adversaries (“social media trolls”) to look like real news but containing false information misleading the readers, making it very difficult to detect fake news using traditional natural language processing-based content analysis methods that dominate scientific literature.

It is an object of the invention to provide novelties for the industrial application.

Accordingly, in one aspect of the invention, what is disclosed is a method of news evaluation in social media networks having a plurality of socially related users, comprising the steps of determining a social graph at least with respect to users and their social relations; determining a news message to be evaluated; determining a propagation behavior of the news message in the social graph; evaluating the news message in view of its determined propagation behavior in the social graph.

Expressed differently, one aspect of the invention can be seen in a method of evaluating information on a social network, wherein the social network comprises at least a plurality of users, social connections between them, user features, and social connections features; and the method comprising the steps of obtaining a pattern of information propagation in the social network by extracting a subset of the users passing the information along their social connections; obtaining propagation features, comprising at least the relative and/or absolute time of information passing from one user to another; evaluating the information using one or more of the propagation features, user features, and social connections features to evaluate; and outputting the information evaluation.

Also, in one aspect of the invention, the invention relates to a method of evaluating input information in view of its spread on at least one social network, wherein the at least one social network comprises at least a plurality of users and social connections between them, user features, and social connections features; the method comprising the steps of obtaining input information data; obtaining input information features based on the input information data; obtaining data on the propagation of the input information on the social network in view of at least a subset of the users passing the information along their social connections; obtaining information propagation features, comprising at least the timing of input information passing from one user to another; evaluating the input information in view of one or more of the information propagation features, user features, social connections features, and input information features; and outputting the input information evaluation.

Thus, a first basic idea of this invention is to exploit spreading patterns for automatic fake news detection. By virtue of being content-agnostic, propagation-based features are likely generalizes across different languages, locales, and geographies, as opposed to content-based features that must be developed separately for each language. Furthermore, controlling the news spread patterns in a social network is generally beyond the capability of individual users, implying that propagation-based features would potentially be very hard to tamper with by adversarial attacks.

While the description frequently relates to the term “news” that are propagated, such “news” may be any kind of input information, in particular a news story, a link, a tweet, a post, a video, an image.

In a preferred embodiment of the invention, the information is a news story, and the evaluation consists in determining whether the story is true or fake; however, any other sort of information (or “news”) can be equally judged to be true or fake.

While the invention mainly focus its attention on fake news detection, it is understood by a person skilled in the art that the same approach can be applied for the evaluation of any information from its spread on a social network or a plurality thereof, including applications such as tweet or post virality prediction.

In some embodiments of the invention, fake news specific propagation patterns are learned by exploiting geometric deep learning, a novel class of deep learning methods designed to work on graph-structured data.

Note that the social graph constitutes a graph to which such deep learning methods may be applied. Furthermore, as the propagation of information takes places on (or “within” or “in”) the social network, the propagation pattern can also be considered to constitute a graph, namely a propagation graph. Accordingly, the step of evaluating the information may comprise applying a graph deep neural network on at least one of the social graph and the propagation graph with their respective vertex-wise functions and edge-wise functions. Also, it is noted that the propagation pattern frequently is based on multiple “Injections” of the information or news message into the network, e.g. because several users independently post a link. This creates “cascades” and accordingly, the propagation of input information on a social network may comprise a plurality of cascades of propagation of said information originated by a plurality of users of said social network. If this is the case, an information propagation features will preferably comprise at least one of the following a union, an average, a maximum, a non-linear function, a parametric learnable function of at least one propagation cascade feature.

It should be noted that the result of an evaluation of a news message could be a classification as “fake news” or “non-fake news”. Basically, this was found to be possible considering empirical evidence that fake and real news spread differently in social media networks. In this context, training and testing data relating to the spreading on Twitter of news stories judged by professional fact-checking organizations to be “real” or “fake” were used. The tests indicated that highly accurate fake news detection is possible in view of the propagation of a news message.

What is more is that fake news messages were found to be reliably detectable at an early stage of propagation within the network, typically after just a few hours of their “injection” into the network. This is considered a particular advantage. The invention in a preferred embodiment may thus rely on propagation information relating to the propagation within less than or equal to the first 24 hours after an injection of the news message into the network, in particular the first injection of the news message into the network; in an even more preferred embodiment the invention will rely on propagation information relating to the propagation within less than the first 12 hours, preferably within less than the first 10, within less than the first 8, within less than the first 6 and in particular less than 5, 4, 3 or 2 hours after an injection of the news message into the network. Note that shorter time may lead to a higher uncertainty or larger confidence range of e.g. a credibility score. Hence, a good compromise is evaluation of propagation of not less than 2, preferably 3 hours and not more than 10, preferably not more than 8, preferably not more than 6 hours. Also, a propagation-based approach for fake news detection is found to have multiple advantages, among which is language-independence; then, propagation-based features can safely be assumed to be significantly more resilient to adversarial attacks, as a hypothetical adversary would need to manipulate the collective behavior of a large part of social network users, a task deemed difficult if not actually impossible.

Nonetheless, it should be noted that the evaluation of fake news need not just result in a classification as “fake news” or “non-fake news”. First of all, true news that actually effect a very large number of people, such as reports relating to severe earth quakes, large scale terrorist attacks and so forth might propagate way faster than usual for “true” but less important or sensational news messages. To take this into account, the result of the evaluation need not be an absolute classification but may also be e.g. a degree of certainty or likelihood or a score of credibility.

Then, a case might occur where certain patterns in general user behavior changes over time. This might lead to different patterns of user behavior and/or news propagation within the network, e.g. because of a site-operator induced adaption of filters for deciding what messages certain users might or might not be interested in.

Also, in certain cases, it might be necessary or sufficient to have some degree of likelihood that a message is fake news to effect an evaluation of propagated facts by human users or other (automatically operated) means. For example, where a fast assessment is necessary due to severe injections of a mixture of fake news, hate speech and correct fact news, it may be advisable to flag news very fast that have a high likelihood of being fake, even though they need to be flagged at a time where a decision in view of propagation alone is insufficient and to then evaluate such messages flagged further.

Therefore, even where there is not an extremely high certainty based on the methods suggested here that a given message is fake news or real, the evaluation may still be helpful. If the likelihood a news message is fake is high in view of the evaluation suggested by the present invention, but the degree of certainty is considered insufficient to classify the news message definitely as fake news, a number of possibilities exist. For example, the news message could be flagged for further evaluation by additional fully computerized steps, such as linguistic evaluation; accordingly, a check could be made whether the content of the message itself or the content found following a link transmitted as message is considered credible in view of automated methods. An automated comparison could be effected comparing the content to content of a similar message from sources judged or predefined to be trustworthy, such as large news agencies, government agencies and the like. Furthermore, the message could be flagged for evaluation by a human operator checking the veracity of the content. Note that evaluations of the same information in more than one network might give improved results.

It will be understood that executing a plurality of computerized steps are typically advisable prior to flagging a news message for human evaluation, as human evaluation is expensive and hence the corresponding possibilities are severely restricted. Also, it will be understood that additional tests may be more computing intensive than that suggested here and/or may be less effective, that is have a lower rate of distinguishing fake news/real news or a lower overall rate of fake news detection.

Note that it is possible to combine the method of the present invention with other methods directly, so that a message could be evaluated both with respect to e.g. the diffusion pattern along the network and a more complete evaluation of user features than in a coarse first evaluation and/or with simultaneous respect to the content of the news message. While this may increase the precision of news classification, even the extremely large amount of messages propagated in asocial media network, it often is preferred to have but a rough evaluation that can be affected on all messages transferred or input in an energy efficient manner.

It should also be noted that other judgments could result other than a decision between a news message being fake news or true news. For example, it might be helpful to determine whether a message reaches hardly any people, whether it reaches a large fraction of relevant target audience and/or whether it goes viral. It can be understood that by the method of the invention, such determination is possible early and that, based on such determination, it may be even possible to identify features of messages or message injections into a social media network that are helpful in letting a message go viral and/or to identify countermeasures that prevent messages from going viral.

It should also be noted that automatically classifying (or evaluating) news is an important step in operating a social media network. It can be used in detecting fake news fully automatically, that is, without any human intervention at all. This might be a case where there is a high certainty that any given message input into the network and distributed within the network actually is hake news. In such a case, preventing further distribution, deleting messages already transmitted, noting whether certain users were actively involved in propagating the message or not could be effected fully automatically and at little computational expense. It is obvious that in this manner, the additional bandwidth or transferred data volume a user consumes for reading messages is kept small, and that the time of a user, the energy consumed or the bandwidth wasted on incorrect data can be reduced. This is considered a significant technical advantage of using the hardware necessary. This advantage may be achieved by the embodiments of the invention. Furthermore, a user that repeatedly or mainly inputs or likes or shares fake news could be flagged as unreliable, could be disregarded or downgraded when it comes to a decision what messages are considered worthwhile propagating in view of the response they obtain from the network community or the unreliable user could be eliminated from the network or be temporally isolated asf.

It should be noted that the social relation between users may simply rate whether a connection exists at all, that is whether information has been shared between users before or whether users state to know each other (Such as by indicating a family relation. e.g. “father/son”, “married to” or “brother/sister”, or by indicating membership in the same groups such as school classes, interest groups, employer/employee relation asf.); in an extremely simple case, however, such rating need not assess how intense the relation or sharing of information is if any relation or sharing of information is given at all. For example, the rating could be independent of the number of times one user has re-posted or liked posts of the second user, if such reposting or liking has taken place in the past at all. It will be understood that this, while being a simple embodiment, is not preferred over e.g. an embodiment where at least the frequency of re-posting or liking is taken into account and/or the time passed since a user has last liked or re-posted the posts of the second user.

Furthermore, a rating of a connection between users would not necessarily have to take into account whether or not both users re-post and/or like posts of the other users in a two-way manner or whether one user only ever “follows” another user, although it might be useful to e.g. have a rating that takes into account and ditinguishes pure follower/followee relations from more symmetric relations; for example, where users represent nodes in the social graph and their social relations are described by edge functions, an edge function f(user n->user m) may differ from the edge function f(user m->user n) describing the reverse relation and accordingly:
f(user n->user m)< >fuser m->user n).

Also note that a rating of the social relation might not only rate existing interconnections; rather, in certain social media networks, a possibility exists to “unfriend”, “unfollow” or “block” certain users. Where two users have had a prior connection and where now they are “unfriended” or “blocked”, obviously, their social relation is different from a relation of two users who simply never had been in contact with each other. Hence, it is reasonable to rate this fact, e.g. by a negative rating. Again, an asymmetry in edge functions may exist rating whether user n has been blocked by user m or vice versa.

It should be noted that when user behavior changes, the neural networks used can be easily adapted so that classification still remains reliable.

In view of the above, it will be understood that the present disclosure also relates inter alia to a method of fake news detection, a method of fake news propagation prevention, a method of news propagation control, a method of data propagation in a social media network, a method of flagging suspicious messages in asocial media network, and a method of evaluating user behavior, where all such methods rely on the (automated and/or computerized) classification and/or evaluation of messages propagating in at least one social media network and/or in a plurality of social media networks (or briefly. “social networks”) as disclosed herein and all such methods are considered to be claimable and inventive over the prior art. Also, it can be used to predict whether a message may go viral, that is, is likely to be perceived by a very large number of users. Predicting whether a message goes viral may be important for a company the viral message relates to, e.g. because the message contains disadvantageous facts or allegations related to a brand product. Here, predicting that a message goes viral may help in damage control. Accordingly, it may be extremely helpful to evaluate, based on the distribution pattern as suggested by the present invention, whether a message goes viral flagging the message as potentially viral identifying by human or automated analysis some or all relevant content it relates to and inform users or non-users of the network that content relevant for them is about to go viral. In particular, where a message relates to or contains a brand name such as VW, Coca-Cola, Apple, Samsung and the like, an alert to a predefined recipient in these companies might be automatically generated. This would constitute an important marketing tool.

As will be obvious, determining the social graph including the social relations of the users is helpful in fake news evaluation. A graph typically is described by nodes and edges and determining the social graph in a preferred embodiment will comprise inputting at least users and their social relations, in particular inputting users into or as nodes of the social graphs whereas their social relations will be described by the edges between the nodes. By analyzing the propagation behavior on the social graph rather than by just determining some feature vector that relates to a propagation behavior per se, enough information can be evaluated so as to evaluate news very fast, that is within mere hours after the injection of news. Obviously, this in turn will help to avoid or reduce adverse effects of fake news propagation at the very onset thereof.

The social graph will typically be described by descriptors indicative of a user characterization and/or of features relating to the social relations.

Regarding the user characterization, it is possible to input into the social graph in which the propagation of the news message may be evaluated a user self-characterization. In other words, the propagation behavior of the news message in the social graph may be evaluated depending on certain properties of a user, for example indicators that could be associated with the credibility or reliability of a user, indicating for example whether or not the user uses a default profile, shows a photography of himself and/or uses a default avatar, allows or forbids geo-tracking and/or has uploaded a variety of photos wherein the user as identified in the file image is shown as well.

Although it can be assumed for some of these parameters to lead to a higher probability of propagating fake news, while for other parameters a lower probability is likely, there is no need to decide whether a given parameter or a given combination of parameters actually does lead to a higher or lower probability of propagating fake news; rather, deep learning methods may be used to trains the system so that it will adapt itself as needed.

A user may be providing consistent information which might be more often or less often found in users propagating fake news. For example, user self-characteristics such as his age, place of birth, religious affiliation, sex, marital status, claimed or proven educational background, employment history and/or self-stated political preferences might be inputted into the social graph.

These parameters or characteristics might be useful as frequently, fake news propagate faster within certain communities sharing for example the same educational background, same political preferences and the same social status as indicated for example by marital status, user age and employment history. Then, characteristics such as a religion may be important, for example where a news message to be evaluated relates to a clerical person such as the Pope, a bishop, a rabbi, an imam and so forth.

It will be obvious that certain news messages are mainly of interest to members of e.g. certain religions and thus, when determining a propagation behavior of a news message in the social graph, religion should be taken into account. The same holds for example for a user name which may be a moniker or a real name and again, such determination may be relevant with respect to use a credibility and/or in a determination whether the user belongs to certain specific, rather “closed” communities. Note that the present invention should and will be applicable even though specific “Filter bubble” algorithms relating to news selection presented to certain users are not known.

It is possible in a preferred embodiment to rely not only on simple numeric, binary or discrete parameters in the user self-characterization where only few choices are available such as age, sex, smoking/non-smoking, and/or marital status: rather, a user self-characterization could be evaluated even where the characterization is an entire text. A previous user activity (history) could be evaluated, for example assigning a given user a likelihood of being involved in fake news propagation where the previous activity of the user points to such behavior. Accordingly, the method of the invention might effect an evaluation of a news message, in particular by judging whether a news message is a fake news message or at least is very likely to be a fake news message in view of the credibility score of a user. Note that such by judging whether a news message is a fake news message or at least is very likely to be a fake news message can be effected in particular in view of one or more of virality, number of views after a period of times, number of retweets/reposts after a period of time, credibility score.

In the same manner, where a user has changed his status frequently, a corresponding characterization could be used for describing the social graph, for example by way of a status changes count of the user. Then, it is feasible and often times advisable to input “favorites” of a user in the social relations. Note that again, not only the favorites might be a relevant feature of the social graph, but that also the number of times these favorites have changed might be relevant: On the one hand, where a user had previous favorites and intensive activities with respect to his previous favorites, it might be assumed that certain topics still stir his interest, in particular where news messages relating to such topics are concerned that are considered surprising. Accordingly, sharing a news message relating to a topic a user previously had favored might be distinguished from the propagation of the same news message by users that never had been concerned or involved with the same topic. It will be understood that it is not necessary to decide aforehand whether or not a specific property or characteristic of a user is relevant and, if so, to what effect and extent.

It will be noted that the user characteristics and/or self characterizations such as user age, marital status and so forth will constitute inhomogeneous data on the node, but it should be understood that it is possible to derive a suitable description allowing processing thereof none the less. It should be noted that even though a variety of user characteristics, characterizations of the social relations among users and so forth shall be inputted into the social graph, it is not necessary to indicate a priori why certain parameters should be entered at all or why or which parameters are considered more important than others.

As a matter of fact, by applying deep learning methods while training a system with spreading patterns known to relate to fraudulent and non-fraudulent content, those parameters that are of particular importance will emerge automatically.

Regarding the social relations, a characterization thereof would be possible in a preferred embodiment inter alia in view of the number of “followers” or “friends” a user associates himself with. Note that where a social graph takes into account the number of followers, friends count and the like, this may be done not only by increasing the number of edges correspondingly, but also by assigning a different weight to each edge depending on whether the user has a high friends count or a low friends count. In particular, where the relations in the network themselves distinguish between “follower” and “followee”, the corresponding edge functions need not be symmetrical in a preferred embodiment. Even in social networks where such distinction is not made can a corresponding asymmetry of edge functions be established, for example in view of the communication history. In cases where one user only or mainly reposts news messages from another user while the other user hardly ever or never re-posts messages by the other user, a follower/followee relation can be established even in cases where the social media network does not provide such categories per se. Then, the duration of a social relation can be evaluated in a preferred embodiment.

It may be preferred to also determine the strength of the social relations in the social graph as indicated for example by the number of common “friends” in the network. Again, these parameters might be used to define an edge function that depends solely or also on the number of common “friends”, on the duration of a social relation and so forth.

It should be noted that another parameter that could be input into the social graph is the aggregation of communication between related users, for example by giving a measure relating to the number of messages one user has posted and the other user has followed.

In a preferred embodiment, the propagation behavior of news message in the social graph may be described by the propagation path in the social graph, time stamps for propagation from graph vertex to vertex, (or “node”, using another common term), and comment data.

In a preferred embodiment, a further feature will be the number of injection points (or entry points) of a news item into the social media network. It will be understood that frequently, the injection of a news message into the social media network will take place in that the user shares the link found elsewhere; for example, the link might relate to a publicly accessible internet site.

Where the social media network has a very large number of users such as Facebook, Twitter and the like, it is likely that more than a single user will independently visit the corresponding internet site and share the corresponding URL; also, messages basically having the same content may be found on different websites. Where the same URL is shared by a plurality of (actually or seemingly) independent users that each inject the message into the social media network, it can be determined that the news message injected by a first user is the same message as a message injected by a second user simply in view of the identical URLs. Here, it is particularly simple to identify the news message injected by different users into the social media network as one and the same message and to treat it correspondingly.

However, there may be other cases where two news messages have the exact same wording but can be found at different websites under different URLs. This may be for example the case where a new product is presented by a company in a bulletin and the different URLs simply identically reproduce the corresponding bulletin. In other instances, there need not even be an identical wording, for example because a bulletin has been redacted or a news information distributed by a news agency has been forming the basis of similar, although not identical messages; also, a case could occur where one and the same event has been observed by a plurality of the different users, for example reporters in a press conference. Even though in the last cases mentioned the wording of the first message would not correspond identically to the wording of a second message, it might still be possible to determine that two messages basically correspond to each other. It should be noted that this can be determined in a straightforward manner for example by way of using hashtags, key words and the like so that despite a large number of messages, identification of messages having very similar or identical content can at least in some cases be straightforward. Note that it is not necessary to have a 100% certainty that a given message is similar to another message to eliminate a fake news message, as each message could still be identified with a high degree of certainty on its own as being a fake or real news message even if it cannot be decided whether it corresponds to another, similar message.

The news item propagation path in the social graph can and will preferably describe the cascading of information from user to user. In this context, it should be noted that in some occasions in the present application, reference is also made to the “diffusion” or “diffusion pattern” of a news message. However, as the example of a news message going viral shows, the term “diffusion” is not to mean that the impact or some other measures of “concentration” of a news item or news message is higher where the diffusion starts. Note that in a standard diffusion process in chemistry, the concentration of the substance diffusing will be highest at the origin of diffusion while farther away from the source, the concentration will be reduced. In contrast, in the context of the present invention, it may suffice to inject one single message and to then have an avalanche-like distribution to sub-subsequent users that let the message go viral. Also, there is no “dilution” of the original message as long as the message itself is passed on. Furthermore, it is noted that a significant cascading may occur at some time and/or after propagation through a limited number of users. Accordingly, there is no “decrease of concentration” as typically associated with a typical diffusion.

However, the information (or “content” or -news item“or news message”) still propagates fro vertex to vertex with a speed depending on both the news message and the social graph structure. Accordingly, the propagation pattern may be considered to be a propagation graph as well. The propagation can be described in view of and/or using time stamps for the propagation from graph vertex to graph vertex, that is by describing the time span a message to needs to pass along the graph. Where a number of different injections of one and the same news message are observed, it may be preferred to use absolute time stamps for propagation rather than merely describing propagation in view of a relative delay of propagation from user to user. In particular, where multiple injections are considered, it may be useful to not only rely on the delay of a message by each injecting user but to also consider the absolute time of injection so as to take into account whether or not multiple injections occur shortly one after the other or whether a longer period inbetween injections is observed. Note that the evaluation of news message propagation may take into account the combined propagation of a message having multiple injections by different users into the social network. As indicated above, it has been found that the propagation pattern (or “diffusion” pattern) of fake news is clearly different from the diffusion pattern of non-fake news.

It is noted that some users do not simply share a link, but also comment the information shared with other users. Such comment data are preferably assessed by the method of the present invention as well: as has been indicated above, the reaction of human users to lake news may be quite different from non-fake, true news. This need not only be reflected by the propagation speed, but also by comment data.

Comment data may be plain text which again can be evaluated in view of key words such as “disgusting”, “great”, “incredible” and so forth; comment data may also be a combination of plain text and emojis or can be only emojis or other signs such as thumb up/thumb down. Such emojis can also be classified and the classification can then be evaluated. For example, a “smiley”, a laughing emoji, a sad emoji or a vomiting emoji or an angry emoji can be distinguished and a respective classifier can be evaluated.

In a preferred embodiment, determining the propagation behavior of the news message in the social graph may comprise determining one or more descriptors indicative of whether or not a message is considered at its source; a time delay before propagating; a reply count; a quote count; a favorite or “like” count; a count indicative of sharing or “re-tweeting.

It should be noted that in certain cases, users may tend to believe a message to be true simply because they have heard of it from different sources, even though each source may be faking news. Therefore, a descriptor indicative of whether or not a message is considered close to its source or whether the message has already spread at least to some degree may be evaluated as well, given that it is more likely that a user has heard of a news message before if the message has propagated further or is older, which might influence the users attitude to sharing the message.

As indicated above, there is a sociological evidence that fake news propagates in a manner differently from real (true) news messages; accordingly, a time delay before propagating, that is, the time between reception of a message and its propagation can be established and when assessing propagation, it is possible to evaluate and take into account at least one of and preferably all of a reply count to the message, a quote count, a favorite or “like” count and a count indicative of sharing or “re-tweeting”. In this manner, group effects can be factored in; for example, a group structure may be such that where a large number of members of a group, even if it is an informal group, like a certain message or statement, a user might feel obliged to also like the message and to propagate it further. This may contribute to the propagation. The same obviously holds for a reply count, comment count or quote count, particularly where a user is interested in attracting attention and reputation.

Then, in a preferred embodiment, it can be taken into account whether a news message is associated with a large number of relevant key words or “hashtags” or specific hashtags of interest to a large number of users, assuming that this renders propagation to a larger number of users more likely than for a message having only a limited number of hashtags or few relevant “keywords” identified in the text.

It should be noted that it is possible to not only analyze the number of hashtags or relevant keywords in a message, but that is also possible to analyze the hashtags themselves. Frequently, a situation may occur where certain topics currently dominate a general public discussion.

Any such topics might then be propagated particularly fast. The hashtags may be relating to such topics of current particular interest to the public and hence, assessment of the hashtags themselves may be important in judging whether the propagation pattern of a news message is indicative of the news being a fake news message.

Note that the hashtags of particular interest to the public may change over time so that in particular with respect to hashtags, it is advisable to adapt the method of evaluating the news message in view of its determined propagation behavior of the social graph repeatedly over time for example by continuously or repeatedly teaching a deep learning system, it is also noted that the propagation behavior of a news message may depend on the data type; oftentimes, a brief video may raise higher tension than a profound but a lengthy textual analysis of an event. Therefore, in a preferred embodiment, the data type may be taken into account when determining the propagation behavior of a news message. Basically, the same holds for text content.

In a preferred embodiment, the determination of the propagation behavior in the social graph comprises applying a graph neural network. In order to understand this, it is noted first of all that a graph neural network is a specific kind of(artificial) neural network.

Artificial neural networks per se were inspired by conventional biological processes. In a living organism, neurons that respond to stimuli are connected via synapses transmitting signals.

The interconnections between the different neurons and the reactions of the neurons to the signals transmitted via the synapses determine the overall reaction of the organism.

In an artificial neural network, nodes are provided that can receive input data as “signals” from other nodes and can output results calculated from the input signals according to some rule specified a respective node. The rules according to which the calculations in each node are effected and the connections between the nodes determine the overall reaction of the artificial neural network. For example, artificial neurons and connections may be assigned weights that increase or decrease the strength of signals outputted at a connection in response to input signals. Adjusting these weights leads to different reactions of the system.

Now, an artificial neural network can be trained very much like a biological system, e.g. a child learning that certain input stimuli—e.g. when a drawing is shown-should give a specific result, e.g. that the word “ball” should be spoken if a drawing is shown that depicts a ball.

It however is important to keep in mind the limitations that are imposed on technical systems. For example, as indicated above, in order to determine whether a given image shows a cat, a house or a dog, the gray values of a large number of the pixels must be considered. Now, even for an image having a modest resolution, this cannot be done by considering all combinations of the gray value of any one pixel with the gray value of every of the other pixels. For instance, even an image of a mere 100 pixels×100 pixels would have 10000 weights for each neuron receiving one pixel. Neither processing nor training would be economically feasible in such a case using hardware available at the time of application.

Thus, what is done to reduce the number of parameters that need to be trained is to consider in a given step only small patches of the image, e.g. tiles of 5×5 pixels so that for every single pixel thereof only a rather small number such as 24 possible interconnections to the other 24 pixel of the patch need to be considered. In order to then evaluate the entire image, this is done in a tiling or overlapping manner; the respective results can then be combined or “pooled”. Thereafter, a further evaluation of the intermediate result, and thereafter, a further pooling asf. can be effected until the final result is obtained.

As a plurality of layers is used and as the reaction of the system has to be trained, this is known as deep learning. Such deep learning can be applied as a graph deep neural network technique on at least one of the social graph and the propagation graph.

In the context of deep learning it is common to state that the “pooling” is done in pooling layers while the other steps are stated to be effected in processing layers. Also, it might be necessary to normalize input or intermediate values and this is stated to be done normalization layers.

The processing can be done in a linear or in a non-linear manner. For example, where a sensor network is considered producing as input values e.g. pressure or temperature measurements, it is possible that large pressure differences or very high temperatures will change the behavior of material between the sensors, resulting in a non-linear behavior of the environment the set of sensors is placed in. In order to take such behavior into account, non-linear processing is useful. If in a layer, non-linear responses need to be taken into account, the layer is considered to be a non-linear layer. Note that while the necessity of non-linear processing could be understood more easily for a sensor network, even in a social media network a non-linear processing can be useful, for example because a large number of previous likes might alter the probability that a recipient of a message considers that such message should be “liked” and passed on by him as well.

Where the processing effected in a processing layer does not take into account the values of all other input or intermediate data but only considers a small patch or neighborhood, the processing layer is considered to be a “local” processing layer, in contrast to a “fully connected” layer.

A particularly advantageous implementation is a convolutional neural network (CNN), in which such a local processing is implemented in the form of a learnable tilter bank. In this way, the number of parameters per layer is O(1), i.e., independent of the input size. Furthermore, the complexity of applying a layer amounts to a sliding window operation, which has O(n) complexity (linear in the input size). These two characteristics make CNNs extremely efficient and popular in image analysis tasks.

As the “pooling” layer typically combines results from a larger number of (intermediate) signals into a smaller number of (intermediate) output signals, the pooling layers are stated to reduce the dimensionality. It will be noted that different possibilities exist to combine a large number of intermediate signals into a smaller number of signals, e.g. a sum, an average or a maximum of the (intermediate layer input signals), an Lₚ-norm or more generally, any permutation invariant function.

Now, while from the above it can be concluded that classical deep neural networks applied in fields such as computer vision and image analysis consist of multiple convolutional layers applying a bank of learnable filters to the input image, as well as optionally pooling layers reducing the dimensionality of the input typically by performing a local non-linear aggregation operation (e.g. maximum), it is necessary to define suitable values for the learnable filters.

Accordingly, the neural network needs to be trained and this usually necessitates to identify, even if not expressis verbis, specific features of a data set that either are or can be used to identify the information needed. Therefore, in using deep learning methods, features are extracted. As the layers in a deep neural network are arranged hierarchically—that is, data is going thru each of the layers in a specific predetermined sequence, the features to be extracted are hierarchical features. It should be noted that in some instances, obtaining a data set for training is difficult. For example, using machine learning for fake news detection in a supervised setting requires a training set of labeled news (“primary dataset”). Such data may be difficult or expensive to obtain. Therefore, in some embodiments of the invention, instead of training a graph neural network on the task of classifying fake news (“primary task”), it is trained on a different task (“proxy task”) for which abundant and inexpensive data is available. For example, one can train a neural network to predict the virality of a tweet (the number of retweets after some time t); the data for such a task does not require any manual annotation. The features learned by such a neural network on the proxy task will also be indicative of the content spreading patterns that are informative for the primary task. Then, the neural network trained on the proxy task can be repurposed for the primary task by a fine-tuning of its parameters or removing parts of its architecture (last layers) and replacing them with new ones suitable for the primary tasks that are trained on the primary data.

Deep learning methods have been very successful for certain types of problems, e.g. image recognition or speech recognition. While in a simple example such as image analysis, where it is obvious what a correct feature (“ball”, “house”) is, in certain application important features are both unknown and deeply hidden in the vast amount of data. For example, if a plurality of genomes are given from patients having either a certain type of cancer or being healthy, while it can be assumed that a certain specific pattern will be present in the genomes of the cancer patient, the pattern may not yet be known and needs to be extracted, but this extraction very obviously will be extremely computationally intensive.

Therefore, with respect to processing an input to determine specific features, it should be kept in mind that such processing is known in both the analogue and the digital domain and different techniques exist for feature extraction.

Before turning to feature extraction in social media networks, it might be helpful to consider the following simple example in the analogue domain. Here, it might be necessary to determine fast, small variations of a signal that slowly varies over time with a large amplitude. This problem would typically best be described as isolating high frequency components from a signal component having a low frequency with a very large amplitude. These components can be easily isolated using filters, in the present case high pass filters. In other words, instead of describing signal processing in the time domain, the Fourier transformation of the input signal is considered and a specific processing in the frequency domain is suggested. It will be understood that the concept of transforming a given input into another domain frequently is helpful to isolate specific features and it will also be understood that methods such as filtering are not only applicable to analogue signals but also to digital data. It is worth noting that where a discrete signal is analyzed, for example a digitized signal, the Fourier spectrum will also consist of discrete frequencies. Also, concepts such as Fourier transformation have been applied not only to one-dimensional input data, but also for example in Fourier optics where the finer details of an image correspond to higher (spatial) frequencies while the coarse details correspond to lower (spatial) frequencies.

Transformation from one domain into another has proven to be an extremely successful concept in fields such as processing of electrical signals. Formally, what is done to determine the effect of filtering is transforming the initial signal into another domain, effecting the signal processing by an operation termed convolution and re-transforming the signal back.

While the mathematical formalism of such “spectral” transformations is well known e.g. as Fourier transformations and while certain adaptions thereof are also well known for better signal processing, such spectral analysis techniques cannot be applied or used with certain type of data structures or input signals easily.

Now, while a Fourier transformation is straightforward to use in certain types of signal processing and is well known in certain areas, using such spectral techniques is far from straightforward for other types of data or data structures. It should be noted that for some of the known methods used extraction of features in order to be applicable, input data need to have a certain structure.

However, the structure of input data will vary largely. For example, pixels in a two dimensional image will be arranged on a two-dimensional grid and thus not only have a clearly defined, small number of neighbors but also a distance between them that is easy to define. A method of extracting features may thus rely on a distance between grid points as defined in standard Euclidean geometry.

In other instances, the data set will not have such a simple Euclidean structure, that is the data will be not Euclidean-structured data, i.e. as they do not lie on regular grids like images but irregular domains like graphs or manifold. As an example for a non-Euclidean data structure graphs or networks should be mentioned. Some examples of graphs are social networks in computational social sciences, sensor networks in communications, functional networks in brain imaging, regulatory networks in genetics, and meshed surfaces in computer graphics.

Generally speaking—and as indicated above-graphs comprise certain objects and indicate their relation to each other. The objects can be represented by vertices in the graph, while the relations between the objects are represented by the edges connecting the vertices. This concept is useful for a number of applications. In social networks, the users could be represented by vertices and the characteristics of users can be modeled as signals on the vertices of the social graph.

Such graphs may interconnect only similar data objects, e.g. human users of a social network, or they may relate to different objects such as companies on the one hand and their employees as additional users on the other hand. Accordingly, the graph can be homogeneous or heterogeneous.

Graphs may be directed or undirected. An example of a network having a directed edge is a (re-)tweeting network, where each vertex represents a user and a directed edge is provided front a first user to a second user if the second user is following the first user. An example for a network having undirected edges is a social network where an edge between two vertices is provided only if the two subjects represented by the vertices mutually consider each other as “friends”. It will be noted that it is possible to define a neighborhood around a vertex, where direct neighbors are those to which a direct edge connection is provided and wherein a multihop neighborhood can be defined as well in a manner counting the number of vertices that need to be passed to reach a “p-hop” neighbor.

A graph may have specific recurring motifs. For example, in a social network, members of a small family will all be interconnected with each other, but then each family member will also have connections to other people outside the family that only the specific member will know. This may result in a specific connection pattern of family members. It may be of interest to identify such patterns or “motifs” and to extract features from data that are specific to the interaction of family members and it might be of particular interest to restrict data extraction to such motifs.

It should also be considered that sometimes, it is not sufficient to only consider the differences neighboring vertices show between their absolute values. This can be done using edge functions. Edge function may describe the relations existing between users in a more or less precise manner.

Thus, if in a pooling layer from a larger number of (intermediate) signals a smaller number of (intermediate) output signals is determined as an aggregate, it may be necessary to take into account not only the values at each vertex but also the values of an edge function.

From the above, it is to be understood that in computing a plurality of edge features, a non-linear edge function could be applied for each neighbor point on the pair of central point feature and neighbor point feature.

It will also be understood that it is possible to define any of a central point function, a neighbor point function and an edge function as a parametric function. The functions can be implemented as neural networks.

Now, with a graph neural network relating to news propagation in the social media network, deep learning methods may in preferred embodiment e.g. help distinguish fake news from true news.

It will be understood that for extracting features om geometric domains, deep learning methods have already been used. It will also be understood that it would be preferred to combine spectral methods of data extraction with methods such as deep learning on geometric domains.

The earliest attempts to apply neural networks to graphs are due to Scarselli, F., Gori, M., Tsoi. A. C., Hagenbuchner, M., Monfardini, G. The graph neural network model. IEEE Transactions on Neural Networks 20(1):61-80, 2009).

Regarding deep learning approaches, and in the recent years, deep neural networks and, in particular, convolutional neural networks (CNNs), reference is made to LeCun. Y., Bottou, L., Bengio, Y., Haffner, P. Gradient-based learning applied to document recognition. Prov. IEEE, 86(1):2278-2324, 1998. The concepts discussed therein have been applied with great success to numerous computer vision-related applications.

With respect to extending classical harmonic analysis and deep learning methods to non-Euclidean domains such as graphs and manifolds, reference is made to Shuman, D. L., Narang, S. K., Frossard, P., Ortega, A., Vandergheynst, P. The emerging field of signal processing on graphs: Extending high-dimensional data analysis to networks and other irregular domains. IEEE Signal Processing Magazine, 30(3):83-98, 2013; and Bronstein. M. M., Bruna, J., LeCun, Y., Szlam, A., Vandergheynst, P. Geometric deep learning: going beyond Euclidean data, arXiv:1611.08097, 2016.

Bruna, J., Zaremba, W., Szlam, A., and LeCun, Y, in “Spectral networks and locally connected networks on graphs” Proc. ICLR 2014 formulated CNN-like deep neural architectures on graphs in the spectral domain, employing the analogy between the classical Fourier transforms and projections onto the eigenbasis of the so-called graph Laplacian operator that will be explained in more detail hereinafter.

In the follow-up work “Convolutional neural networks on graphs with fast localized spectral filtering” by Defferrard, M., Bresson, X., and Vandergheynst, P, in Proc NIPS 2016) an efficient filtering scheme using recurrent Chebyshev polynomials was proposed, which reduces the complexity of CNNs on graphs to the same complexity of standard CNNs oi regular Euclidean domains.

In a paper entitled “Semi-supervised classification with graph convolutional networks” arXiv:1609.02907, 2016, Kipf, T, N. and Welling. M. proposed a simplification of Chebyshev networks using simple filters operating on 1-hop neighborhoods of the graph.

In “Geometric deep learning on graphs and manifolds using mixture model CNNs”. Proc. CVPR 2017, Monti. F, Boscaini, D. Masci. J., Rodola. E., Bronstein, M. M, introduced a spatial-domain generalization of CNNs to graphs using local patch operators represented as Gaussian mixture models, showing a significant advantage of such models in generalizing across different graphs.

Generally, geometric deep learning naturally deals with heterogeneous data (such as user demographic and activity, social network structure, news propagation and content), thus carrying the potential of being a unifying framework for content, social context, and propagation based approaches. However, in this context, it is worthwhile to note that generally, geometric deep learning is used as an umbrella term referring to extensions of convolutional neural networks to geometric domains, in particular, to graphs.

Such neural network architectures are known under different names, and are referred to as intrinsic CNN (ICNN) or graph CNN (GCNN). Note that a prototypical CNN architecture consists of a sequence of convolutional layers applying a hank of learnable filters to the input, interleaved with pooling layers reducing the dimensionality of the input. A convolutional layer output is computed using the convolution operation, defined on domains with shift-invariant structure, e.g. in discrete setting, regular grids. A main focus here is in on special instances, such as graph CNNs formulated in the spectral domain, though additional methods were proposed in literature. Reference is made in particular to M. M. Bronstein. J. Bruna, Y. LeCun, A. Szlam, P. Vandergheynst, Geometric deep learning: going beyond Euclidean data IEEE Signal Processing Magazine 34(4): 18-42, 2017.

Such methods known in the art will now be explained in more detail using graphs as an example and introducing certain concepts in a more precise manner. Note that this explanation is helpful in fully understanding how a graph neural network can be implemented, but that nonetheless, the methods described are known per se in the art and could thus be assumed to be also known to the average skilled person.

Accordingly, a graph [symbol] =(v, ε, w) may be considered that consists of a set [symbol] ={1, . . . , n} of n vertices, a set ε={(i,j): i, j∈v}⊆v×v of edges (an edge being a pair of vertices), on which a weight is defined as follows: wᵢⱼ>0 if (i,j)∈ε and wᵢⱼ=0 if (i,j)∉ε. The weights can be represented by an n×n adjacency (or weight) matrix w=(wᵢⱼ).

The graph is said to be undirected whenever (i,j)∈εiff(j,i)∈ε for all i,j, and is directed otherwise. For undirected graphs, the adjacency matrix is symmetric, w^{T}=w.

Furthermore, we denote by
x=(x₁, . . . , xₙ)^{T} functions defined on the vertices of the graphs

One can then construct the (unnormalized) graph Laplacian as an operator acting on the vertex functions, in the form of a symmetric positive-semidefinite matrix where the

graph Laplacian is Δ=D−W,
with D=dag(Σⱼ₌₁wᵢⱼ) being the diagonal degree matrix, containing at position i,i the sum of all weights of edges emanating from vertex i. For undirected graphs, Δ is a symmetric matrix.

The Laplacian is a local operation, in the sense that the result of applying the Laplacian at vertex i is given by

(Δf)ᵢ=Σ_{j:ij∈ε}wᵢⱼ(xᵢ−xⱼ) (1)

In other words, the result obtained from applying the Laplacian is influenced only by the value at a vertex and its neighbourhood. Equation (1) can be interpreted as taking a local weighted average of x in the neighbourhood of i, and subtracting from it the value of xᵢ.

It will be noted that in the example of a graph having vertices and edges as discrete elements, locality can be understood by referring only to those other elements that can be reached “hopping” along edges from vertex to vertex, so that a 1-hop, 2-hop, 3-hop asf, neighborhood can be defined. However, locality could also be defined where the underlying geometric domain is continuous rather than discrete. There, locality would be given if Δf only depends on an infinitesimally small neighborhood.

Thus, the graph Laplacian is only a particular example of a local operator that can be applied on data on a geometric domain in general, and a graph in particular.

The geometric interpretation of the Laplacian given above is that a (weighted) averaging of the data in the neighbourhood of a vertex and subtracting the data at the vertex itself is performed. This operation is linear in its nature. However, it will be understood that other operators exist that will provide for local processing and will be linear.

Accordingly, it will be noted that rather than specifically referring to the graph Laplacian defined above, reference could be made to other such local operators in general and it will be understood that different local operators exist. e.g. adapted to specific geometric domains, so that inter alia graph Laplacian operators, graph motif Laplacian operators, point-cloud Laplacian operators, manifold Laplace-Beltrami operator or mesh Laplacian operators are known and could be referred to and used. It will thus be understood that the invention can be applied by a person skilled in the art to other definitions of graph Laplacians: furthermore, the definition of Laplacians on other geometric domains, both continuous and discrete, is analogous to the above definitions and therefore the constructions presented hereinafter can be applied to general geometric domains by a person skilled in art. It will be obvious that a specific Laplacian may or should be used because either a specific data structure is given or because specific needs are addressed. For example, it is possible to define processing operators based on small subgraphs (called motifs) that can handle both directed and undirected graphs.

In a preferred embodiment, the graph neural network will be trained on examples of news message items having known class labels such as “fake news”, “true news”, “viral news” and so forth.

It is noted that in a preferred embodiment, the graph neural network is one of the following: spectral graph convolutional neural network, spatial graph convolutional network, mixture model network, Chebyshev network, Cayley network, message passing network, graph attention network, motif network.

These will now be described with respect to the drawing in some more detail.

### BRIEF DESCRIPTION OF THE DRAWINGS

FIG. 1A depicts a neighbourhood of a point on geometric domain and data associated therewith;

FIG. 1B depicts the computation of a Laplacian operator on a geometric domain;

FIG. 1C depicts different neighbourhoods of two different points on a geometric domain;

FIG. 2 A,B,C depicts the local operator according to some embodiments of the invention;

FIG. 3 depicts the processing functions according to some embodiments of the invention;

FIG. 4A, B depict the construction of motif Laplacians on a directed graph;

FIG. 4C depicts graph motifs;

FIG. 5 depicts an example of a single news story spreading on a subset of the Twitter social network with social connections between users being visualized as light blue edges and a news URL retweeted by multiple users denoted as cascade-roots in red each producing a cascade propagating over a subset of the social graph as indicated by red edges with circle size representing the number of followers to more clearly indicate that some cascades are small and contain only the tweeting user and/or just a few retweets;

FIG. 6 depicts the distribution of cascade sizes (number of tweets per cascade) in the dataset of the Example;

FIG. 7 depicts the distribution of cascades over the 930 URLs available in the dataset of the example with at least six tweets per cascade, sorted by the number cascades in descending order; (the first 15 URLs (˜1.5% of the entire dataset) correspond to 20% of all the cascades);

FIG. 8 depicts a subset of the Twitter network used in a study with estimated user credibility where vertices represent users, gray edges the social connections: (vertex color and size encode the user credibility (blue=reliable, red=unreliable) and the number of followers of each user, respectively, with numbers 1 to 9 representing the nine users with most followers);

FIG. 9 depicts the architecture of the neural network model of the example with the abbreviations in the top row: GC=Graph Convolution. MP=Mean Pooling. FC=Fully Connected, SM=SoftMax layer and input/output tensors received/produced by each layer shown in the bottom row;

FIG. 10 depicts the performance of URL-wise (blue) and cascade-wise (red) fake news detection using 24 hr long diffusion time; (shown are ROC curves averaged on five folds (the shaded areas represent the standard deviations) with ROC AUC being 92.70±1.80% for URL-wise classification and 88.30±2.74% for cascade-wise classification, respectively, considering only cascades with at least 6 tweets were considered for cascade-wise classification):

FIG. 11 depicts the T-SNE embedding of the vertex-wise features produced by the neural network of the example at the last convolutional layer representing all the user in the study, color-coded according to user credibility (blue=reliable, red=unreliable), indicating that clusters of users with different credibility clearly emerge, indicative that the neural network learns features useful for fake news detection;

FIG. 12 depicts the performance of cascade-wise fake news detection (mean ROC AUC, averaged on five folds) using minimum cascade size threshold; (best performance is obtained by filtering out cascades smaller than 6 tweets);

FIG. 13 depicts ablation study result on URL-wise (top) I cascade-wise (bottom) fake news detection, using backward feature selection by showing the performance (ROC AUC) for the model of the example trained on subsets of features, grouped into four categories: user profile, network and spreading, content, and user activity and with groups being sorted for importance from left to right;

FIG. 14 depicts the performance of URL-wise (top) and cascade-wise (bottom) fake news detection (mean ROC AUC, averaged on five folds) as function of cascade diffusion time;

FIG. 15 depicts effects of training set aging on the performance of URL-(top) and cascade-wise (bottom) fake news detection with the horizontal axis showing difference in days between average date of the training and test sets, the effect showing the test performance obtained by the model of the example with 24 hrs diffusion (solid blue), test performance obtained with same model just using the first tweet of each piece of news (0 hrs diffusion, dashed orange), and test performance obtained training on the original uniformly sampled five folds (with veracity predictions being computed for each URL cascade when this appears as a test sample in the 24 hrs five fold cross-validation, green).

Now, regarding graph neural networks, it is helpful to be aware of the following

Choosing an undirected graph and its symmetric graph Laplacian as an example simple to understand, it can be shown that such a Laplacian admits an eigendecomposition of the form

Δ=ΦΛΦ^{T}, where
Φ=(ϕ₁, . . . ϕₙ) denotes the matrix of orthonormal eigenvectors
and
A=diag(λ₁, . . . , λₙ) denotes the diagonal matrix of the corresponding eigenvalues,

Where in classical harmonic analysis of a discrete signal, a discrete Fourier transformation is determined, only certain fixed frequencies (referred to as “Fourier atoms”) are considered rather than considering a continuous spectrum. In the example, the eigenvectors play the role of these Fourier atoms in classical harmonic analysis and the eigenvalues can be interpreted as their frequencies.

With this analogy, given a function x=(x₁, . . . , xₙ)^{T} on the n vertices of the graph, its graph Fourier transform can be defined as

\hat{x}=Φ^{T}x.

Again, by analogy to the Convolution Theorem in the Euclidean case, the spectral convolution “*” of two functions x, y can then be defined as the element-wise product of the respective Fourier transforms,

x*y=Φ(Φ^{T}y)o(Φ^{T}x)=Φ diag(ŷ₁, . . . ,ŷₙ)\hat{x} (2)

Note, that this convolution can be determined if the matrix ϕ is known from the eigendecomposition of the Laplacian.

This approach has been used in the prior art to implement filters in the spectral domain for graphs. In more detail, J. Bruna, W. Zaremba, A. Szlam, Y. LeCun in “Spectral Networks and Locally Connected Networks on Graphs”, Proc. ICLR 2014) used the spectral definition of convolution (2) to generalize CNNs on graphs.

To this end, a spectral convolutional layer in this formulation is used that has the form

$${x}_{l} \text{?} = ξ ( {\sum }_{{i}^{′} = 1}^{{q}^{′}} Φ Y \text{?} {u}^{′} {Φ}^{T} {x}_{l}^{′} ) , l = 1 , … , q , \\ \text{?} \text{indicates text missing or illegible when filed} \qquad ( 3 )$$

where
q′ and q denote the number of input and output channels (or “data entries”) that are inputted into and outputted from the layer, respectively,
Y_{u′} is a diagonal matrix of spectral multipliers representing a filter in the spectral domain; note that this filter is learnable, that is, the filter values would be adjusted by training.
ξ is a nonlinearity, e.g. hyperbolic tangent, sigmoid, or rectified linear unit (ReLU) applied on the vertex-wise function values.
   and, as before
x=(x₁, . . . , xₙ)^{T} is a function defined on the vertices of the graph,
Φ=(ϕ₁, . . . ϕₙ) again denotes the matrix of orthonormal eigenvectors resulting from the eigendecomposition of the Laplacian.

Thus, according to equation (3), the output of the convolutional layer is obtained by determining for each input q′ a function x_{l′}, to which a filter as described by Y_{u′} is applied and then the respective signals obtained from all inputs (or data entries) q′ treated in this manner are aggregated and a nonlinear result is derived from the aggregate using ξ1.

However, unlike classical convolutions carried out efficiently in the spectral domain using FFT, this is significantly more computationally expensive. First, as there are no FFT-like algorithms on general graphs for the computations of the forward and inverse graph Fourier transform, multiplication by the matrices Φ, Φ^{T} are necessary, having a complexity of O(n²) where here and in the following the “Big-O notation” is used to denote complexity order. Secondly, the number of parameters representing the liters of each layer of a spectral CNN is O(n), as opposed to O(1) in classical CNNs. Third, there is no guarantee that the filters represented in the spectral domain are localized in the spatial domain, which is another important property of classical CNNs. In other words, applying the filter might lead to a situation where the output from a given patch of the geometric domain might be influenced by values of points outside the patch, potentially from points very far away on the domain.

Hence, this simple approach known in the art has severe drawbacks. A further approach has been suggested by M. Defferrard, X. Bresson. P. Vandergheynst in “Convolutional Neural Networks on Graphs with Fast Localized Spectral Filtering. Proc. NIPS2016).

For using what is known as Chebyshev Networks (or ChebNet) according to Defferrard et al., a rescaled Laplacian having all of its eigenvalues all in the interval [−1,1]. It is noted that such a rescaled Laplacian can be obtained from a non-rescaled Laplacian by defining

\tilde{Δ}=2λₙ⁻¹Δ−I

where

\tilde{Δ}=2λₙ⁻¹Δ−I is the rescaled Laplacian

and

\tilde{Λ}=2λₙ⁻¹Λ−I are the eigenvalues of the rescaled laplacian in the interval [−1,1]. Now, a polynomial filters of order p (in some cases, represented in the Chebyshev polynomial basis can be defined as

$$τ \text{?} ( λ \text{?} ) = {\sum }_{j = 0}^{p} {θ}_{j} {T}_{j} ( λ \text{?} ) , \\ \text{?} \text{indicates text missing or illegible when filed} \qquad ( 4 )$$

where
\tilde{λ} is the frequency resealed in [−1,1],
θ [symbol] is the (p+1)-dimensional vector of polynomial coefficients parameterizing the filter,
   and
[symbol] ⱼ(λ)=2λ [symbol] ⱼ₋₁(λ)− [symbol] ⱼ₋₂(λ) denotes the Chebyshev polynomial of degree j defined in a recursive manner with [symbol] ₁(λ)=λ and [symbol] ₀(λ)=1.

This known approach benefits from several advantages. First, the filters are parameterized by O(1) parameters, namely the p+1 polynomial coefficients. Second, there is no need for an explicit computation of the Laplacian eigenvectors, as applying a Chebyshev filter a function x=(x₁, . . . , xᵤ)^{T} defined on the vertices on a simply amounts to determining the right side of equation (5) given by

[symbol]

(\hat{Δ})x=Σⱼ₌₀^{p}θⱼ [symbol] ⱼ(\tilde{Δ})x (5)

Now, first, due to the recursive definition of the Chebyshev polynomials, this only incurs applying the Laplacian p times with p being the polynomial degree. Then, second, multiplication by a Laplacian has the cost of O(|ε|), and assuming the graph has |ε|=O(n) edges, which is the case for k-nearest neighbours graphs and most real-world networks, the overall complexity is O(n) rather than O(n²) for equation (3) operations, similarly to classical CNNs. Third, since the Laplacian is a local operator affecting only 1-hop neighbours of a vertex and accordingly its pth power affects only the p-hop neighbourhood, so the resulting filters are spatially localized. Thus. Chebyshev networks effectively already reproduce the computationally appealing characteristics of classical Euclidean CNNs.

Regarding other networks mentioned above, mixture Model Networks (MoNet) were proposed e.g. in Monti et al. “Geometric deep learning on graphs and manifolds using mixture model CNNs”, NIPS 2017. Such MoNets are spatial-domain Graph CNN generalizing the notion of ‘patches’ to graphs. The neighbors of each vertex i are assigned local pseudo-coordinates uᵢⱼ∈ [symbol] ^{d}, j∈ [symbol] ᵢ. The analogue of a convolution is then defined as a Gaussian mixture in these coordinates,

$${x}_{i}^{′} = {\sum }_{𝓁 = 1}^{L} {ω}_{𝓁} {\sum }_{j ∈ {𝒩}_{i}} \frac{{k}_{μ} \text{?} , \sum \text{?} ( {u}_{ij} )}{{\sum }_{{j}^{′} ∈ {𝒩}_{i}} {k}_{μ} \text{?} , \sum \text{?} ( {u}_{{ij}^{′}} )} {x}_{j} where$$

$${k}_{μ} \text{?} \sum ( u ) = exp ( - \frac{1}{2} {( u - μ )}^{T} {\sum }^{- 1} ( u - μ ) )$$

$$\text{?} \text{indicates text missing or illegible when filed}$$

are Gaussian kernels and μ₁, . . . , μ_{M}∈ [symbol] ^{d} and Σ₁, . . . , Σ_{M}∈ [symbol] ₊^{d} are their learnable parameters. The Gaussians define local weights extracting the local representation of f around i that can be regarded as a generalization of a ‘patch’: the additional learnable parameters w₁, . . . w_{M} correspond to the filter coefficients in classical convolution.

Furthermore, a graph Attention Networks (GAT) was proposed in Velickovic et al., “Graph attention networks”, ICLR 2018, that uses an attention mechanism for directly learning the relevance of each neighbor for the convolution computation. The basic convolution operation with attention has the form:

$${x}_{i}^{′} = {\sum }_{j ∈ 𝒩} {α}_{ij} {x}_{j}$$

$${α}_{ij} = \frac{{e}^{η ( ( a \vert {f}_{i} , {f}_{j} \vert ) )}}{{\sum }_{k ∈ 𝒩} \text{?} {e}^{η ( ( a \vert {f}_{i} , {f}_{j} \vert ) )}}$$

$$\text{?} \text{indicates text missing or illegible when filed}$$

where η denotes the Leaky ReLU, and a([fᵢ, fⱼ]) is some transformation of the concatenated features at vertices i and j, implemented as a fully connected layer. By replicating this process multiple times with different transformations (multiple heads), filters capable of focusing on different classes of vertices in a neighborhoods are achieved. It is noted that GAT cart be considered as a particular instance of MoNet, where the pseudo-coordinates uᵢⱼ are just the features of the nodes i and j.

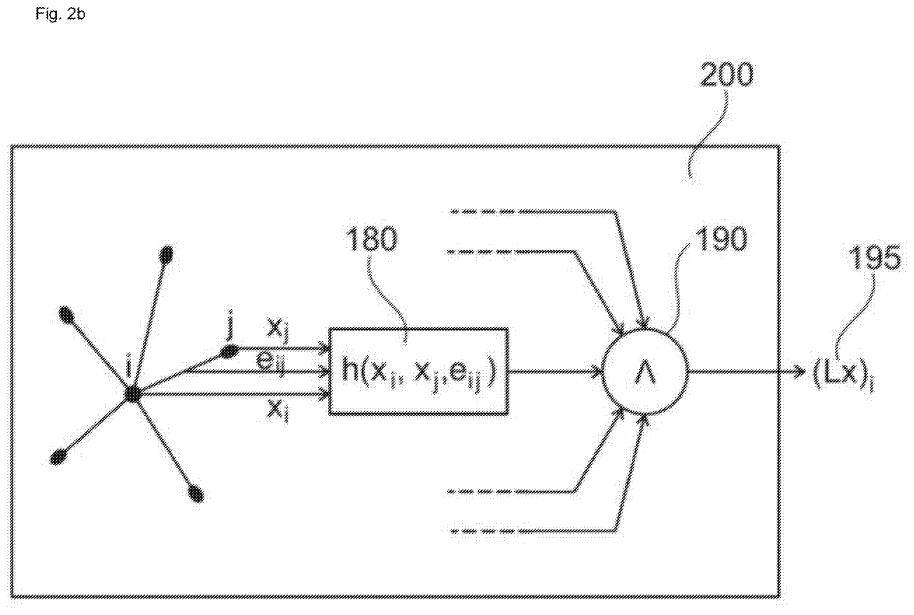

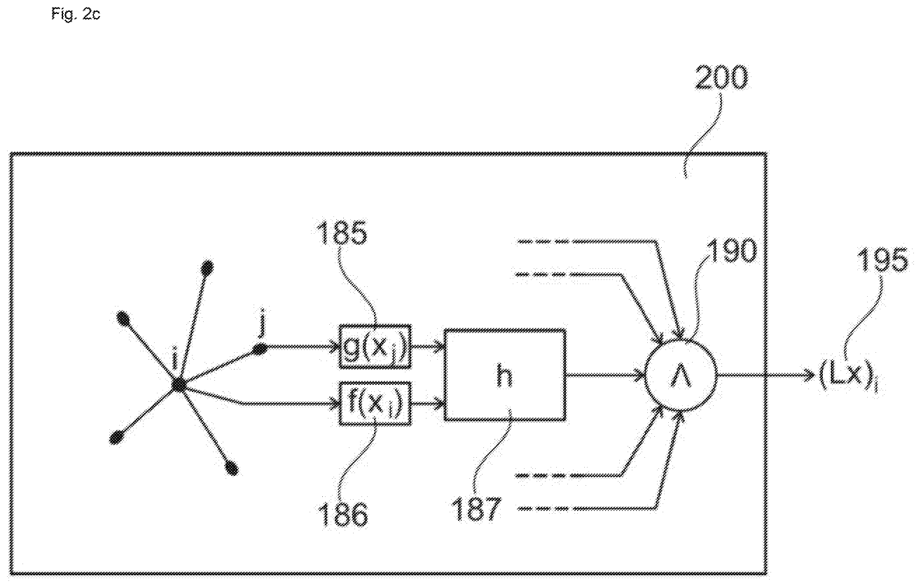

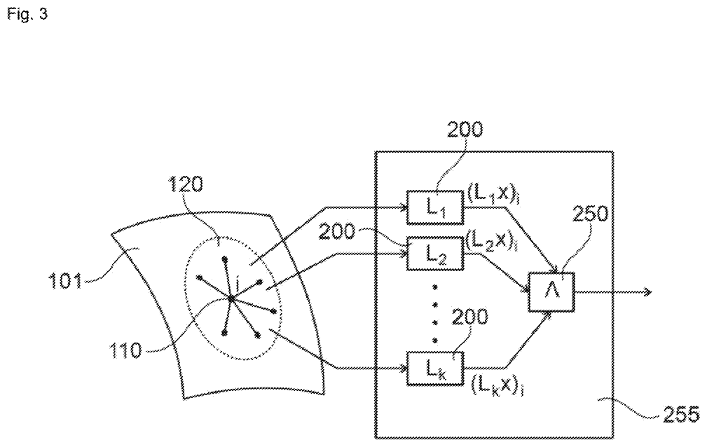

The most general model encompassing the above methods comprises two key components: local operator 200 and an operator function 250, where the numbers refer to FIGS. 2 and 3.

The basic building block 255 of various embodiments of the present invention is one or more local operators 200 applied to data on a geometric domain 101, followed by an operator function 250; an intrinsic deep neural network architecture may consist or make use of one or more sequences of such basic operations. Like in classical neural networks, such intrinsic layers can be interleaved with pooling operations, fully connected layers, and non-linear functions.

In some embodiments, both or any of the local operator and the operator functions can have learnable parameters. In some embodiments, both or any of the local operator and the operator functions can themselves be implemented as small. In some embodiments (as exemplified in FIG. 3), more than a single local operator 200 may be used, each of which having different, shared, or partially shared learnable parameters.

A local operator 200 can be defined as follows.

Let

x: [symbol] → [symbol] ^{d}^{ᵥ}

and

e:ε→ [symbol] ^{d}^{_{ε}}

be general vector-valued functions defined on the vertices and edges of the graph, respectively, that can be represented as matrices
X of size n×dᵥ
   and
E of size |ε|×d_{ε}, respectively.

While for simplicity in some of the examples given below, it is assumed that all the values are real, it is understood that a person skilled in the art can apply the present invention to the setting when complex-values functions are used. Even more general, vertex- and edge-functions can be any sets of features representing e.g. users in a social networks and their respective social relations, and can comprise both numerical and categorical data.

Furthermore, let
i∈ [symbol] be a vertex 110 of a graph (or more generally, point on a geometric domain), and let [symbol]
   ᵢ⊂ε be the neighbourhood 120 of i:
   for simplicity of discussion, we consider a particular case of 1-ring [symbol] ᵢ={j:ij∈ε}) though other neighbourhoods can be used in the present invention by a person skilled in art.

Considering a single vertex (point) 110 i on the metric domain 101, one thus has the central point data xᵢ, for each of j∈ [symbol] ᵢ, neighbour point data xⱼ, and neighbour edge data eᵢⱼ, denoted by numbers 150, 155, and 170, respectively.

The result of a local operator L at vertex i can then be defined as follows:

(L(X,E))ᵢ=Λ_{j∈N}_{ᵢ}h(xᵢ,xⱼ,eᵢⱼ) (6)

where
h: [symbol] ^{2dp+d}^{_{ε}}→ [symbol] ^{d}^{ᵥ}^{ⁱ} is a local processing function 180 that can be either a fixed function or a parametric function with learnable parameters;
   and
Λ is a local aggregation operation 190, e.g. (weighted) sum, mean, maximum, or in general, any permutation-invariant function.

The aggregation operation 190 can also be parametric with learnable parameters. Note that the function h is sensitive to the order of features on vertices i and j, and hence can handle directed edges.

In one of the embodiments, as a particularly convenient form of the local processing function what is used is a local processing function

h(f(xᵢ),g(xⱼ))

where
f: [symbol] ^{d}^{ᵥ}→ [symbol] ^{d}^{ᵥ}^{′} is a central point function 186,
g: [symbol] ^{d}^{ᵥ}→ [symbol] ^{d}^{ᵥ}^{″} is a neighbour point function 185,
   and
h: [symbol] ^{d}^{ᵥ}^{′+d}^{ᵥ}^{″}→ [symbol] ^{d}^{ᵥ}^{′″} is the edge function 187.

The functions ƒ, g, h can be either fixed or parametric with learnable parameters.

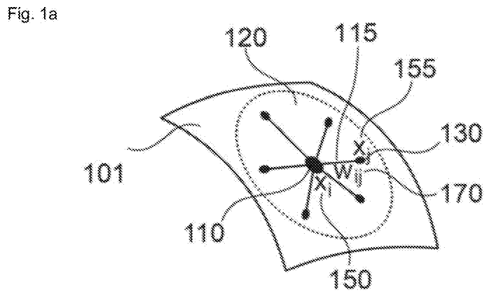

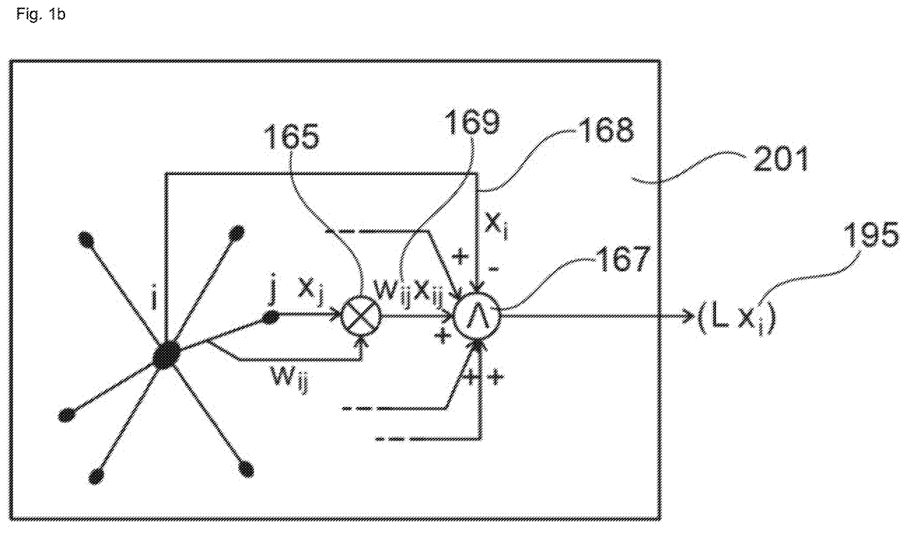

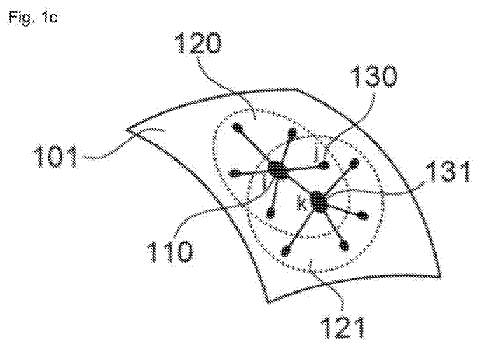

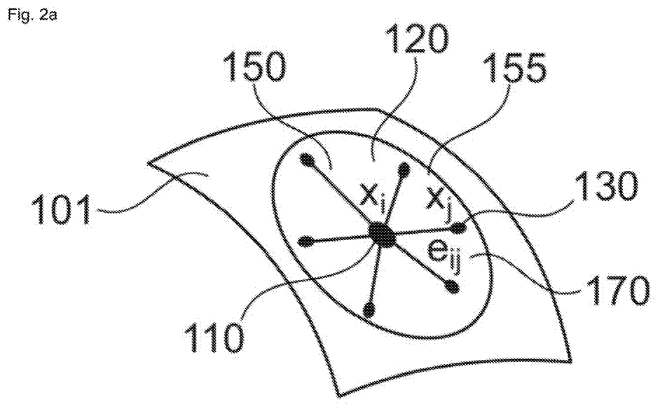

One implementation of the graph Laplacian (exemplified in FIG. 1) then is a particular example of a local operator with h=xᵢ−xⱼ and Λ=Σ is the (weighted) summation operation. In this setting, h is invariant to the order of the vertices i and j. A non-linear Laplacian-type operator can be obtained by using edge function of the form h(f(xᵢ)−g(xⱼ)).

To the local operator, different operator functions 250 can be applied, where application is understood as applying the function to the spectrum of the operator (when the operator is linear).

The operator L can be either linear of non-linear; furthermore, more than a single operator may be involved. The operator function 250, denoted by τ, is expressed in terms of simple operations involving one or more local operators L₁, . . . , L_{g}, such as:
scalar multiplication a L, where a is a real or complex scalar;
nonlinear scalar function applied element-wise f(L);
operator addition L₁+L₂;
operator multiplication (or composition) L₂L₁, understood as a sequential application of L₁ followed by L₂;
operator inversion L⁻¹:
   and any combination thereof.

In one of the embodiments of the inventions, the operator function τ is a multi-variate polynomial of degree p w.r.t. multiple operators L₁, . . . , L_{A};

$$τ ( {L}_{1} , … , {L}_{K} ) = {\sum }_{j = 0}^{p} {θ}_{{k}_{1} , … , {k}_{j}} {\sum }_{{k}_{1} , … , {k}_{j} ∈ \{ 1 , … , K \}} {L}_{{k}_{j}} \text{?} … \text{?} {L}_{{k}_{1}} \\ \text{?} \text{indicates text missing or illegible when filed} \qquad ( 7 )$$

where the convention is that for j=0 one has a zero-degree term θ₀I. A polynomial of the form (7) has

$$\frac{1 + {K}^{p + 1}}{1 - K}$$

coefficients: in some embodiments, it might be beneficial to make the coefficients dependent to reduce the number of free parameters.

In one of the embodiments of the inventions, the operator function τ is a Padé rational function of the form

$$τ ( L ) = {θ}_{0} + {\sum }_{j = 1}^{p} {{θ}_{j} ( 1 + {β}_{j} L )}^{- 1} \qquad ( 8 )$$

where θⱼ, βⱼ are the learnable parameters. A multi-variate version of (8) can be used by a person skilled in the art.

In some embodiments of the invention, more than a single operator function τ₁, . . . , τ_{M} may be used, each of which having different, shared, or partially shared learnable parameters.

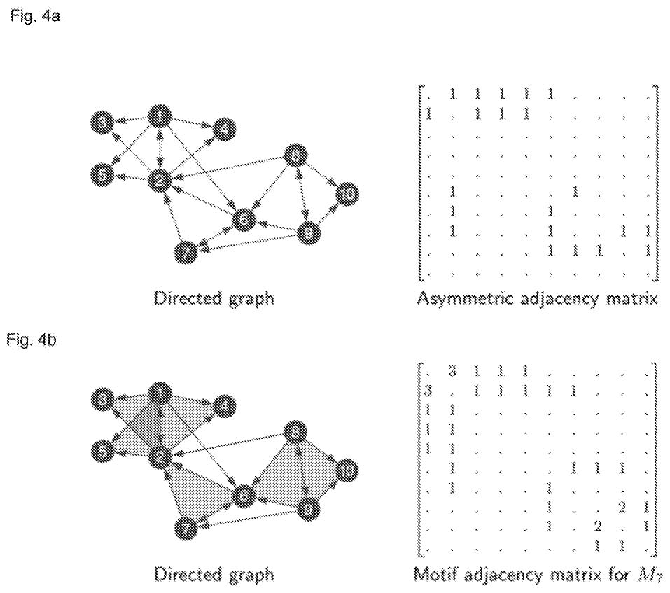

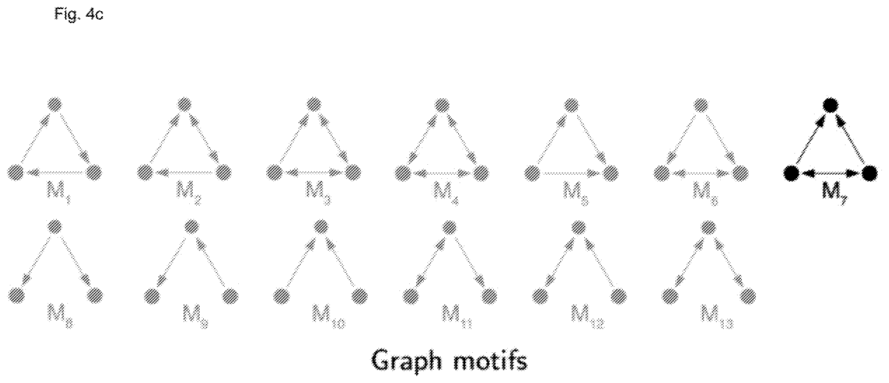

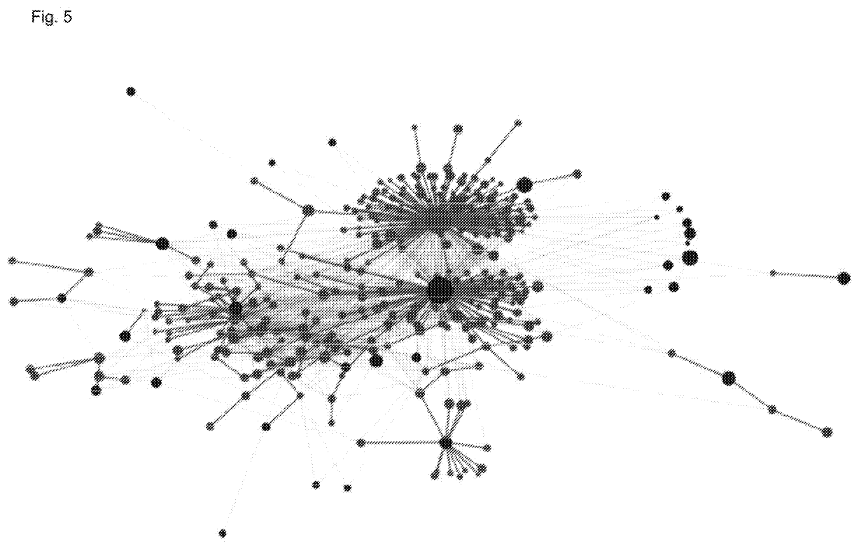

Motif-based operators. In one of the embodiments, processing operators based on small subgraphs (called motifs) are used, allowing to handle both directed and undirected graphs. Let [symbol] ={V, ε, W} be a weighted directed graph (in which case W^{T}≠W, or at least not necessarily so), and let [symbol] ₁, . . . , [symbol] _{K} denote a collection of graph motifs (small directed or undirected graphs representing certain meaningful connectivity patterns; an example in FIG. 4C depicts thirteen 3-vertex motifs), For each edge (i, j)∈ε of the directed graph [symbol] and each motif [symbol] ₖ, let u_{k,ij} denote the number of times the edge (i,j) participates in [symbol] ₖ (note that an edge can participate in multiple motifs, as shown in FIG. 4B, where edge (1,2) participates in 3 instances of the motif [symbol] ₇). One can define a new set of edge weights of the form \tilde{w}_{k,ij}=u_{k,ij}wᵢⱼ, which is now a symmetric motif adjacency matrix denoted by \tilde{W}ₖ (a reference is made to A. R. Benson, D. F. Gleich, and J. Leskovec. “Higher-order organization of complex networks,” Science 353(6295):163-166, 2016).

The motif Laplacian \dot{Δ}ₖ=I−\dot{D}ₖ^{-1/2}\dot{W}ₖ\dot{D}ₖ^{-1/2} associated with this adjacency acts anisotropically with a preferred direction along structures associated with the respective motif,

In one of the embodiments of the invention, the multivariate polynomial (7) w.r.t. the K motif Laplacians \tilde{Δ}₁, . . . , \tilde{Δ}_{K} is used as the operator function τ. To reduce the number of coefficients, in some of the embodiments of the invention, a simplified version of the multivariate polynomial (7) can be used involving only two motifs, e.g. incoming and outgoing directed edges

τ(\tilde{Δ}₁,\tilde{Δ}₂)=τ₀I+θ₁\tilde{Δ}₁+θ₂\tilde{Δ}₂+θ₁₁\tilde{Δ}₁²+ . . . +θ₂₂\tilde{Δ}₂²+ (9)

In another embodiment of the invention, recursive definition of polynomial (7) can be used,

$$τ ( {\tilde{Δ}}_{1} , … , {\tilde{Δ}}_{K} ) = {\sum }_{j = 0}^{p} {θ}_{j} {P}_{j} ;$$

$${P}_{j} = {\sum }_{k = 1}^{K} {α}_{k , j} {\tilde{Δ}}_{k} {P}_{j - 1} , j = 1 , … , p$$

$${P}_{0} = I ,$$

Cayley tilters. In one of the embodiments, the operator function τ is a Cayley rational function (or Cayley polynomial). A Cayley polynomial of order p is a real-valued function with complex coefficients,

$${τ}_{c , h} ( λ ) = {c}_{0} + Re \{ {\sum }_{j = 1}^{p} {{c}_{j} ( h λ - ι )}^{j} {( h λ + ι )}^{- j} \} \qquad ( 10 )$$

where τ=\sqrt{−1} denotes the imaginary unit, c is a vector of one real coefficient and p complex coefficients and h> is the spectral zoom parameter, that will be discussed later. Both or some of these parameters can be optimized during training. A Cayley flier G is a spectral filter defined by applying the Cayley polynomial to a Laplacian operator (or in general to any local operator), which is then multiplied by the input data vector x.

$$G x = {τ}_{c , h} ( Δ ) x = {c}_{0} x + Re \{ {\sum }_{j = 1}^{p} {{c}_{j} ( h Δ - ι I )}^{j} {( h Δ + ι I )}^{- j} x \} \qquad ( 11 )$$

Similarly to polynomial (Chebyshev) filters, Cayley filters involve basic matrix operations such as powers, additions, multiplications by scalars, and also inversions. This implies that application of the filter Gx can be performed without explicit expensive eigendecomposition of the Laplacian operator. In the following, it is shown that Cayley filters are analytically well behaved; in particular, any smooth spectral filter can be represented as a Cayley polynomial, and low-order filters are localized in the spatial domain. One can also discuss numerical implementation and compare Cayley and Chebyshev filters.

Cayley filters are best understood through the Cayley transform, from which their name derives, Denote by [symbol] ={e^{1θ}:θ∈ [symbol] } the unit complex circle. The Caley transform

$$𝒞 ( x ) = \frac{x - ι}{x + ι}$$

is a smooth bijection between [symbol] and [symbol] \{1}. The complex matrix [symbol] (hΔ)=(hΔ−t1)(hΔ+t1)⁻¹ obtained by applying the Cayley transform to the scaled Laplacian hΔ has its spectrum in [symbol] and is thus unitary. Since z⁻¹=z̅ for z∈ [symbol] one can write [symbol] =c̅ⱼ [symbol] ^{-j}(hΔ). Therefore, using 2Re{z}=z+z̅, any Cayley filter (11) can be written as a conjugate-even Laurent polynomial w.r.t. [symbol] (hΔ),

$$G = {c}_{0} I + {\sum }_{j = 1}^{p} {c}_{j} {𝒞}^{j} ( h Δ ) + {\overline{c}}_{j} {𝒞}^{- j} ( h Δ ) \qquad ( 12 )$$

Since the spectrum of [symbol] (hΔ) is in [symbol] , the operator [symbol] ^{j}(hΔ) can be thought of as a multiplication by a pure harmonic in the frequency domain [symbol] for any integer power j,

$${𝒞}^{j} ( h Δ ) = Φ [ \begin{matrix}{𝒞}^{j} ( h {λ}_{1} ) & & \\ & ⋱ & \\ & & {𝒞}^{j} ( h {λ}_{n} )\end{matrix} ] {Φ}^{T}$$

A Cayley filter can be thus seen as a multiplication by a finite Fourier expansions in the frequency domain [symbol] . Since (12) is conjugate-even, it is a (real-valued) trigonometric polynomial.

Note that any spectral filter can be formulated as a Cayley filter. Indeed, spectral filters τ(λ) are specified by the finite sequence of values τ(λ₁), . . . , τ(λₙ), which can be interpolated by a trigonometric polynomial. Moreover, since trigonometric polynomials are smooth, we expect low order Cayley filters to be well localized in some sense on the graph, as discussed later. Finally, in definition (10) complex coefficients are used. If cⱼ∈ [symbol] then (12) is an even cosine polynomial, and if cⱼ∈t [symbol] then (12) is an odd sine polynomial. Since the spectrum of hΔ is in [symbol] ⁺ U{0}, it is mapped to the lower half-circle by [symbol] , on which both cosine and sine polynomials are complete and can represent any spectral filter. However, it is beneficial to use general complex coefficients, since complex Fourier expansions are overcomplete in the lower half-circle, thus describing a larger variety of spectral filters of the same order without increasing the computational complexity of the filter.

To understand the essential role of the parameter h in the Cayley filter, consider [symbol] (hΔ). Multiplying, Δ by h dilates its spectrum, and applying [symbol] on the result maps the non-negative spectrum to the complex half-circle. The greater h is, the more the spectrum of hΔ is spread apart in [symbol] ⁺ U{0}, resulting in better spacing of the smaller eigenvalues of [symbol] (hΔ). On the other hand, the smaller h is, the further away the high frequencies of hΔ are from ∞, the better spread apart are the high frequencies of [symbol] (hΔ) in [symbol] . Tuning the parameter h allows thus to ‘zoom’ in to different parts of the spectrum, resulting in filters specialized in different frequency bands.

The numerical core of the Cayley filter is the computation of [symbol] ^{j}(hΔ)x for j=1, . . . , p performed in a sequential manner. Let y₀, . . . , yₚ denote the solutions of the following linear recursive system,

y₀=x

(hΔ+d)yⱼ=(hΔ−d)yⱼ₋₁,j=1, . . . ,p (13)

Note that sequentially approximating yⱼ in equation (13) using the approximation of yⱼ₋₁ in the right hand side is stable, since [symbol] (hΔ) is unitary and thus has condition number 1.

The recursive equations (13) can be solved with matrix inversion exactly, but it costs O(n³). An alternative is to use an iterative solves such as the Jacobi method, which provides approximate solutions \tilde{y}ⱼ≈yⱼ.

In a preferred embodiment, the graph neural network may be applied to the full social graph. This may be preferred because then, the best available information may be assessed. For example, a pattern might exist due to the non-propagation of certain messages by certain users thus terminating a propagation chain. However, it is noted that applying the graph neural network to the full social graph may require a large number of computations which may be considered disadvantageous in view of the computational expense. Accordingly, in other cases and embodiments, it might be preferred to apply the graph neural network only to the subgraph of the social graph involved in the news message propagation. This obviously reduces the computational load. In certain cases, it might be preferable to not only consider the subgraph of the social graph involved in the news message propagation, but to add a one-hop-neighborhood, two-hop-neighborhood and so forth of each user who has propagated, commented, received and so forth the news message under consideration.

It is preferred if the graph neural network comprises one or more graph convolutional layer and/or one or more graph pooling layer.

As will be obvious from the above, the present invention makes use of the strong evidence found in the literature that real and fake news tend to spread differently. Accordingly, the present invention suggests and takes advantage of the possibility or learning spreading patterns indicative of fake content. The method suggested is a data driven approach exploiting deep learning methods designed to work on graph-structured data and referred to as geometric deep learning. This approach in an embodiment is used rather than a traditional approach of analyzing the actual news content to find out merely in view of the content whether or not a news message is false.

The geometric deep learning method suggested here to be used in an embodiment has been shown to outperform previous approaches in a broad range of applications already involving graph data; however, the ability to learn fake news behavior patterns on social networks is considered normal with respect to fake news detection. As will be understood from the above and the detailed examples given herein below, the underlying core algorithm is a generalization of convolution neural networks that already have achieved remarkable success in image applications.

### EXAMPLE

In a practical example, the spreading of news stories on Twitter verified by professional fact-checking organizations was considered. For such news, the propagation patterns were used in a Geometric Deep Learning approach to distinguish news messages known to be fake news from verified news messages.

The approach was taken in a manner so as to allow learning from data the relevant kind of social context features, combining information on user demographics, reaction, and news spread for the fake news detection task.

It could be shown that despite the lack of context analysis, a very significant improvement due to the ability to learn task-specific graph features from the data compared to previous approaches using hand-crafted features could be achieved; therefore, geometric deep learning methods can be considered to offer a significant breakthrough in automatic fake news detection, in particular in view of the fact that the method disclosed is able to deal with fake news of any level of sophistication and with Fake news of any language. It should be noted that controlling the news spread patterns in asocial network is beyond the capability of individual users, implying that the method disclosed is potentially very hard to defy by adversarial behavior.

In more detail, a dataset was used comprising a collection of news verified by several fact-checking organizations such as Snopes; each of the source fact-checking organizations provides an achieve of news with an associated short “claim” relating to the content of a message (e.g. ‘Actress Allison Mack confessed that she sold children to the Rothschilds and Clintons’) and “label” determining the veracity of the claimed content (‘false’ in the above example).

First, from such archives, an overall list of fact-checking articles was gathered and for simplicity, any article relating to news claims with doubtful labels, such as ‘mixed’ or ‘partially true/false’ were deleted from further consideration.

Second, for each of the remaining claims, potentially related URLs referenced by the fact-checkers, were identified, filtering out all those not mentioned at least once on Twitter.

Third, trained human annotators were employed to ascertain whether the web-pages associated with the collected URLs were matching or denying the related claim or were simply unrelated to that.

This way of proceeding provided for a simple method to propagate truth-labels from fact-checking verdicts to URLs: if a URL matches a claim, then it directly inherits the verdict; if it denies a claim, it inherits the opposite of the verdict (e.g. URLs matching a true claim are labeled as true, URLs denying a true claim are labeled as false). While this is laborious, the dataset obtained is considered very clean.

The last part of the data collection process consisted in the retrieval of Twitter data related to the propagation of news associated with a particular URL. The news diffusion tree produced by a URL-containing source tweet and all of its retweets, termed hereinafter “cascade”. For each URL remaining in the filtered set, the related cascades were determined as well as their Twitter-based characterization by drawing edges among users according to Twitter's social network.

Using the labeled training set of graphs representing the spread of news items (containing user demographic features, associated posts, and their timestamps) associated with fake and real news, a graph neural network was trained.

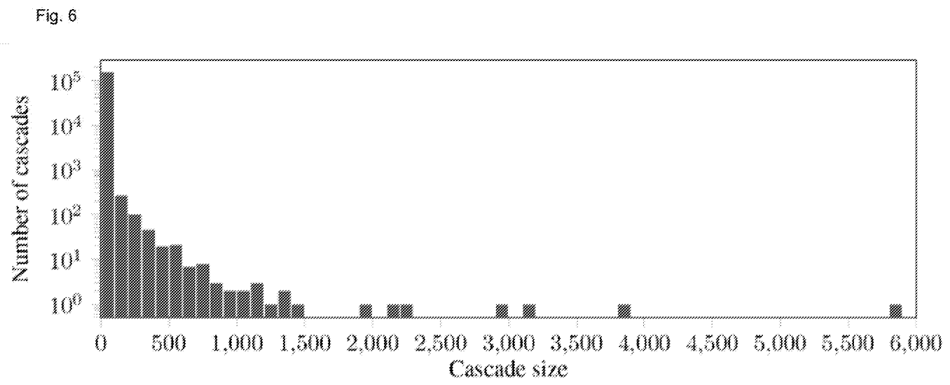

Overall, the collection consisted of 1,084 labeled claims, spread on Twitter in 158,951 cascades covering the period from May 2013 till January 2018. The total number of unique users involved in the spreading was 202,375 and their respective social graph comprised 2.443, 996 edges. As we gathered 1,129 URLs, the average number of article URLs per claim is around 1.04; as such, a URL can be considered as a good proxy for a claim in the dataset and one can thus use the two terms synonymously hereinafter. It is also noted that a large proportion of cascades were of small size (the average number of tweets and users in a cascade is 2.79, see also FIG. 6 depicting the distribution of cascade sizes), which required to use a threshold on a minimum cascade size for classifying these independently in some experiments (see details hereinbelow).

Features

The following features describing news, users, and their activity were extracted, grouped into four categories; User profile (geolocalization and profile settings, language, word embedding of user profile self-description, date of account creation, and whether it has been verified.) User activity (number of favorites, lists, and statuses), Network and spreading (social connections between the users, number of followers and friends, cascade spreading tree, retweet timestamps and source device, number of replies, quotes, favorites and retweets for the source tweet), and Content (word embedding of the tweet textual content and included hashtags).

Credibility and Polarization

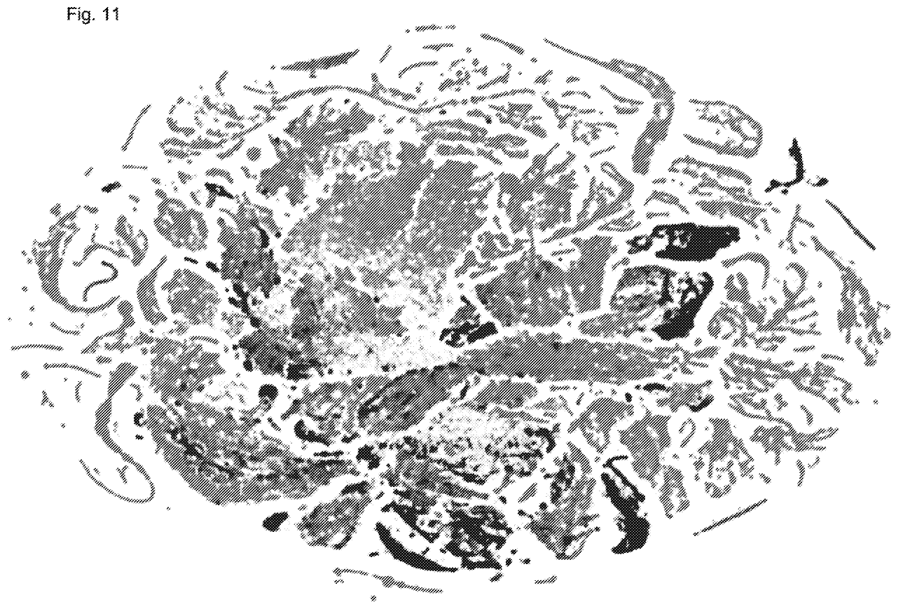

The social network collected in the study manifests noticeable polarization depicted in FIG. 11. Each user in this plot is assigned a credibility score in the range [−1, +1] computed as the difference between the proportion of (re)tweeted true and fake news (negative values representing fake are depicted in red, more credible users are represented in blue). The node positions of the graph are determined by topological embedding computed via the Fruchterman-Reingold force-directed algorithm, grouping together nodes of the graph that are more strongly connected and mapping apart nodes that have weak connections. It was observed that credible (blue) and non-credible (red) users tend to form two distinct communities, suggesting these two categories of tweeters prefer to have mostly homophilic interactions. While a deeper study of this phenomenon is beyond the scope of this example, it was noted that similar polarization has been observed before in social networks, e.g. in the context of political discourse and might be related to ‘echo chamber’ theories that attempt to explain the reasons for the difference in fake and true news propagation patterns.

Geometric Deep Learning Model

In the past decade, deep learning techniques have had a remarkable impact on multiple domains, in particular computer vision, speech analysis, and natural language processing. However, most of popular deep neural models, such as convolutional neural networks (CNNs), are based on classical signal processing theory, with an underlying assumption of grid-structured (Euclidean) data. In recent years, there has been growing interest in generalizing deep learning techniques to non-Euclidean (graph- and manifold-structured) data. Early approaches to learning on graphs predate the recent deep learning renaissance and are formulated as fixed points of learnable diffusion operators. The modern interest in deep learning on graphs can be attributed to the spectral CNN model of Bruna et al, cited above. Since some of the first works in this domain originated in the graphics and geometry community, the term geometric deep learning is widely used as an umbrella term for non-Euclidean deep learning approaches.

Broadly speaking, graph CNNs replace the classical convolution operation on grids with a local permutation-invariant aggregation on the neighborhood of a vertex in a graph. In spectral graph CNNs, this operation is performed in the spectral domain, by utilizing the analogy between the graph Laplacian eigenvectors and the classical Fourier transform; the filters are represented as learnable spectral coefficients. While conceptually important, spectral CNNs suffer from high computational complexity and difficulty to generalize across different domains. Follow-up works showed that the explicit eigendecomposition of the Laplacian can be avoided altogether by employing functions expressible in terms of simple matrix-vector operations, such as polynomials or rational functions. Such spectral filters typically scale linearly with the graph size and can be generalized to higher order structures, dual graphs (edge filters), and product graphs.

The Laplacian operator is only one example of fixed local permutation-invariant aggregation operation amounting to weighted averaging. More general operators have been proposed using edge convolutions, neural message passing, local charting, and graph attention. On non-Euclidean domains with local low-dimensional structure (manifolds, meshes, point clouds), more powerful operators have been constructed using e.g. anisotropic diffusion kernels.

Being very abstract models of systems of relations and interactions, graphs naturally arise in various fields of science. For this reason, geometric deep learning techniques have been successfully applied across the board in problems such as computer graphics and vision, protection against adversarial attacks, recommendation systems quantum chemistry and neutrino detection, to mention a few.

Architecture and Training Settings

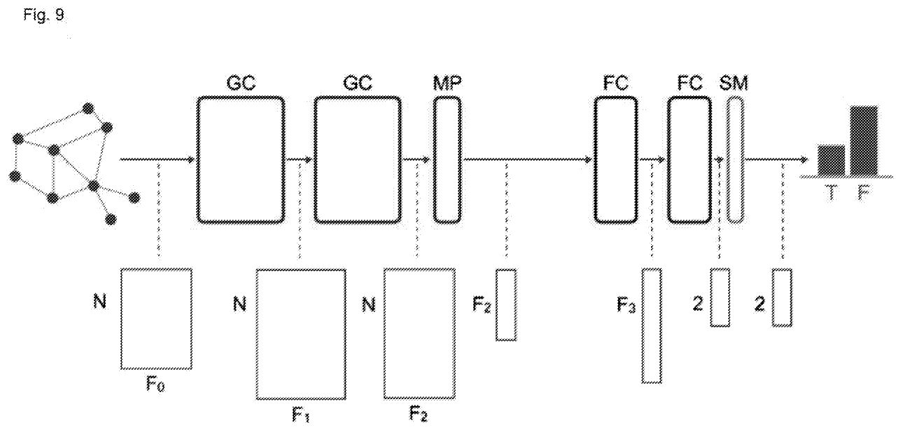

The deep learning model of the example is described below. A four-layer Graph CNN was used with two convolutional layers (64-dimensional output features map in each) and two fully connected layers (producing 32- and 2-dimensional output features, respectively) to predict the fake/true class probabilities. In FIG. 9 a block diagram of the model is depicted. One head of graph attention was used in every convolutional layer to implement the filters together with mean-pooling for dimensionality reduction. A Scaled Exponential Linear Unit (SELU) was used as non-linearity throughout the entire network. Hinge loss was employed to train the neural network (hinge loss was preferred to the more commonly used mean cross entropy as it outperformed the latter in early experiments). No regularization was used with the model.

Input Generation

Given a URL u (or a cascade c arising from u) with corresponding tweets Tᵤ={tᵤ¹, . . . , tᵤⁿ}, mentioning it, u was described in terms of graph [symbol] ᵤ.

[symbol]

ᵤ has tweets in [symbol] ᵤ as nodes and estimated news diffusion paths plus social relations as edges. In other words, given two nodes i and j, edge (i, j)∈ [symbol] ᵤ iff at least one of the following holds: i follows j (i.e. the author of tweet i follows the author of tweet j), j follows i, news spreading occurs from i to j, or from j to i.

News diffusion paths defining spreading trees were estimated by jointly considering the timestamps of involved (re)tweets and the social connections between their authors. Given tᵤⁿ the retweet of a cascade related to URL u, and {tᵤ⁰, . . . , tᵤⁿ⁻¹} the immediately preceding (re)tweets belonging to the same cascade and authored by users {aᵤ⁰, . . . , aᵤⁿ}, then:

1. if aᵤⁿ follows at least one user in {aᵤ⁰, . . . , aᵤⁿ⁻¹}, news spreading was estimated to tᵤⁿ from the very last tweet in {tᵤ⁰, . . . , tᵤⁿ⁻¹} whose author is followed by aᵤⁿ;
2. if aᵤⁿ does not follow any of the users in {aᵤ⁰, . . . , aᵤⁿ⁻¹}, news spreading was conservatively estimated to tᵤⁿ from the user in {aᵤ⁰, . . . , aᵤⁿ⁻¹} having the largest number of followers (i.e. the most popular one).

Finally, nodes and edges of graph [symbol] ᵤ have features describing them. Nodes, representing tweets and their authors, were characterized with all the features presented hereinafter. As for edges, features were used representing the membership to each of the aforementioned four relations (following and news spreading, both directions). The approach to defining graph connectivity and edge features allows, in graph convolution, to spread information independently of the relation direction while potentially giving different importance to the types of connections. Features of edge (i, j) are concatenated to those of nodes i and j in the attention projection layer to achieve such behavior.

Results

The example considered two different settings of fake news detection: URL-wise and cascade-wise, using the same architecture for both settings.

In the first setting, it was attempted to predict the true/fake label of a URL containing a news story from all the Twitter cascades it generated. On average, each URL resulted in approximately 141 cascades. In the latter setting, which is significantly more challenging, it was assumed to be given only one cascade arising from a URL and attempted to predict the label associated with that URL. The assumption is that all the cascades associated with a URL inherit the label of the latter. While we checked this assumption to be true in most cases in the dataset, it is possible that an article is for example tweeted with a comment denying its content. It is noted that an analysis of comments accompanying tweets/retweets shall be helpful as well when evaluating news.

Model Performance

For URL-wise classification, five randomized training/test/validation splits were used. On average, the training, test, and validation sets contained 677, 226, and 226 URLs, respectively, with 83.26% true and 16.74% false labels (±0.06% and 0.15% for training and validation/test set respectively).

For cascade-wise classification the same split initially realized for UR L-wise classification (i.e. all cascades originated by URL u are placed in the same fold as u). Cascades containing less than 6 tweets were discarded; the reason for the choice of this threshold is motivated below. Full cascade duration (24 hr) was used for both settings of this experiment. The training, test, and validation sets contained on average 3586, 1195, 1195 cascades, respectively, with 81.73% true and 18.27% false labels (±3.25% and 6.50% for training and validation/test set respectively).

The neural network was trained for 25×103 and 50×103 iterations in the URL- and cascade-wise settings, respectively, using AMSGrad with learning rate of 5×10−4 and mini-batch of size one.

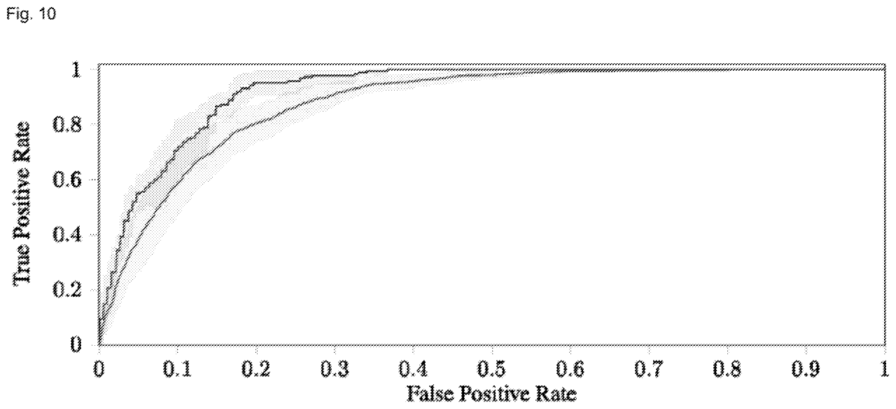

In FIG. 10 the performance of URL-(blue) and cascade-wise (red) fake news classification represented as a tradeoff(ROC curve) between false positive rate (fraction of true news wrongly classified as fake) and true positive rate (fraction of fake news correctly classified as fake) is shown. The area under the ROC curve (ROC AUC) was used as as an aggregate measure of accuracy. On the above splits, the method achieved mean ROC AUC of 92.70±1.80% and 88.30±2.74% in the URL- and cascade-wise settings, respectively.

In FIG. 11 a low-dimensional plot of the last graph convolutional layer vertex-wise features obtained using t-SNE embedding is depicted. The vertices are colored using the credibility score defined in Section 2. The example observes clear clusters of reliable (blue) and unreliable (red) users, which is indicative of the neural network learning features that are useful for fake news classification.

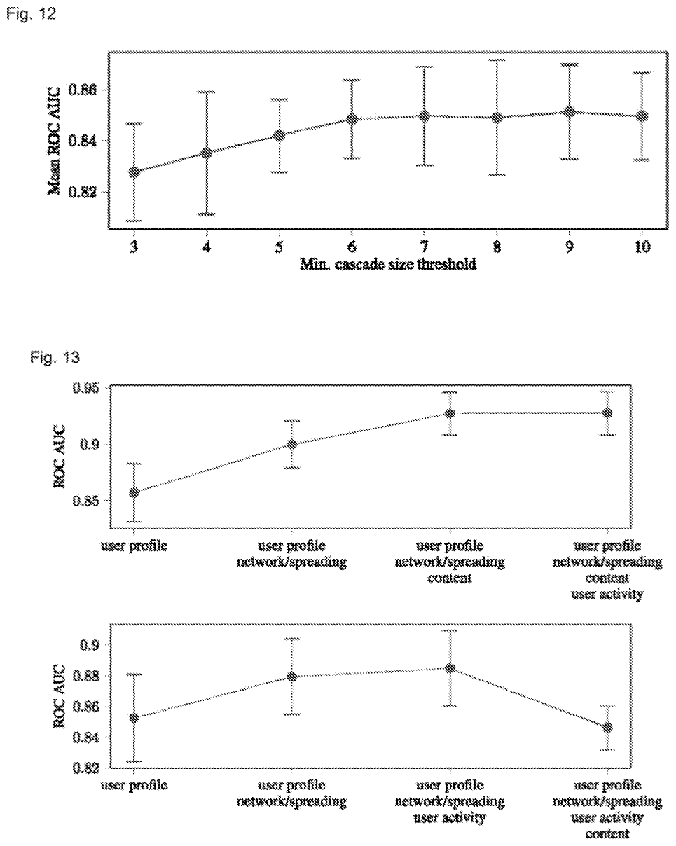

Influence of minimum cascade size. One of the characteristics of the dataset is the abundance of small cascades containing just a few users (see FIG. 6). Since the approach relies on the spreading of news across the Twitter social network, such examples may be hard to classify, as too small cascades may manifest no clear diffusion pattern. To identify the minimum useful cascade size, the example investigated the performance of the model in the cascade-wise classification setting using cascades of various minimum sizes (FIG. 12). As expected, the model performance increases with larger cascades, reaching saturation for cascades of at least 6 tweets (leaving a total of 5,976 samples). This experiment motivates the choice of using 6 tweets as the minimum cascade size in cascade-wise experiments in the study.

Ablation study. To further highlight the importance of the different categories of features provided as input to the model, an ablation study can be conducted by means of backward-feature selection, Four groups of features defined above were considered: user profile, user activity, network and spreading, and content. The results of ablation experiment are shown in FIG. 13 for the URL-(top) and cascade-wise (bottom) settings. In both settings, user-profile and network/spreading appear as the two most important feature groups, and allow achieving satisfactory classification results (near 90% ROC AUC) with the proposed model.

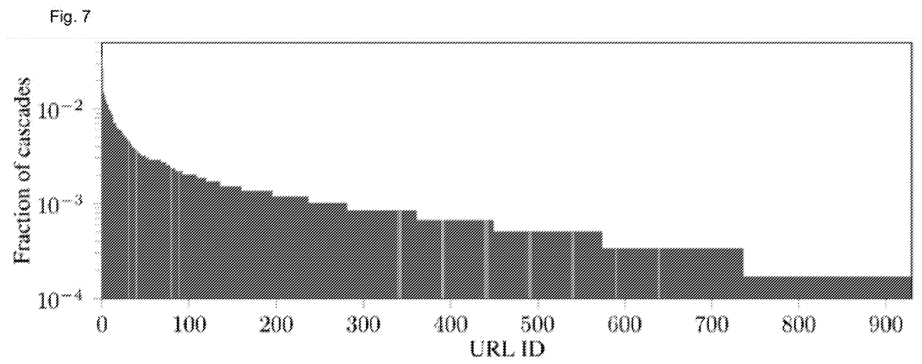

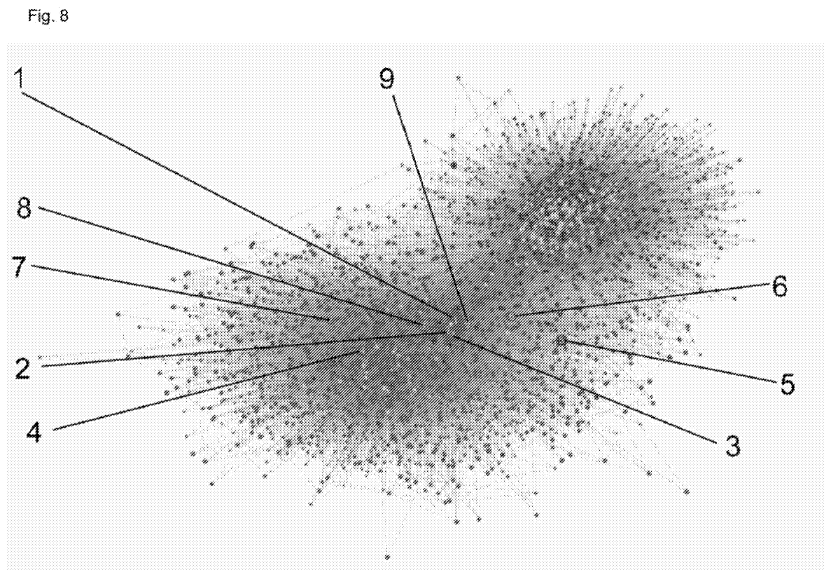

Interestingly, in the cascade-wise setting, while all features were positively contributing to the final predictions at URL-level, removing tweet content from the provided input improves performance by 4%. This seemingly contradictory result can be explained by looking at the distribution of cascades over all the available URIs (FIG. 7): 20% of cascades are associated to the top 15 largest URLs in our dataset (˜1.5% out of a total of 930). Since tweets citing the same URL typically present similar content, it is easy for the model to overfit on this particular feature. Proper regularization (e.g. dropout or weight decay) may thus be introduced to avoid overfitting and improve performance at test time. For simplicity, by leveraging the capabilities of the model to classify fake news in a content-free scenario, it was decided in the example to completely ignore content-based descriptors (tweet word embeddings) for cascade-wise classification and let the model exploit only user- and propagation-related features.

News Spreading Over Time

One of the key differentiators of propagation-based methods from their content-based counterparts, namely relying on the news spreading features, potentially raises the following question: for how much time do the news have to spread before they can be classified them reliably? A series of experiments was conducted to study the extent to which this is the case with the approach.

For this purpose, the cascades were truncated after time t starting from the first tweet, with t varying from 0 (effectively considering only the initial tweet, i.e. the ‘root’ of each cascade) to 24 hours (the full cascade duration) with one hour increments. The model was trained separately for each value of t. Five-fold cross validation was used to reduce the bias of the estimations while containing the overall computational cost.

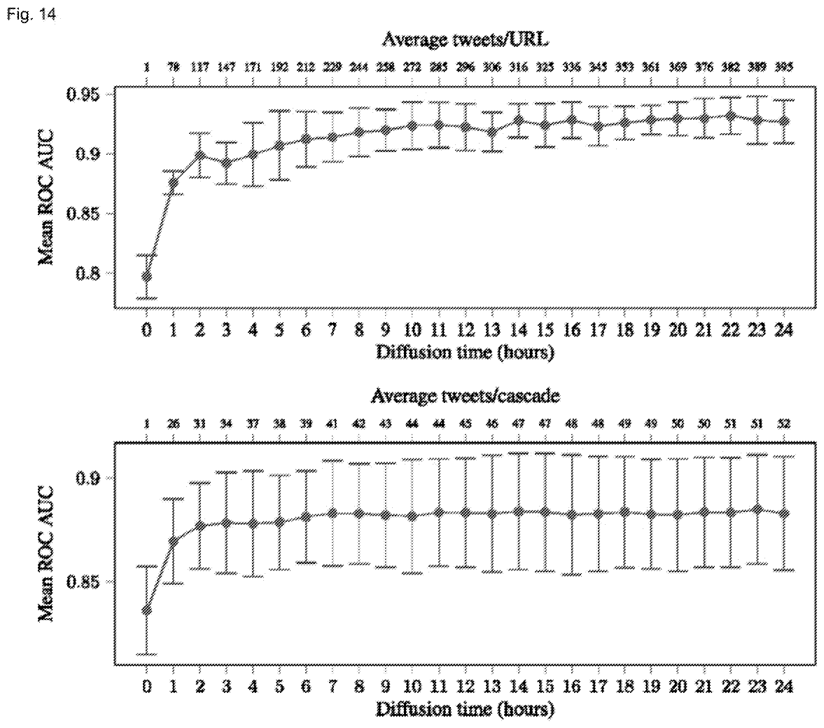

In FIG. 14 the performance of the model (mean ROC AUC) as function of the cascade duration is depicted, for the URL-(top) and cascade-wise (bottom) settings. As expected, performance increases with the cascade duration, saturating roughly after IS hours in the URL-wise setting and after 7 hours in the cascade-wise one, respectively. This different behavior is mainly due to the simpler topological patterns and shorter life of individual cascades. Seven hours of spreading encompass on average around 91% of the cascade size; for the URI, wise setting, the corresponding value is 68%. A similar level of coverage, 86%, is achieved after 15 hours of spreading in the URL-wise setting. It is also noted that remarkably just a few (˜2) hours of news spread are sufficient to achieve above 90% mean ROC AUC in URL-wise fake news classification. Furthermore, a significant jump in performance from the 0 hr setting (effectively using only user profile, user activity, and content features) to ≥1 hr settings (considering additionally the news propagation) was observed, which was interpreted as another indication of the importance of propagation-related features.

Model Aging

Given that the model is to be used in a dynamic world with constantly evolving political context, the social network, user preferences and activity, news topics and potentially also spreading patterns are assumed to evolve in time.

Hence, it is helpful to understand to what extent a model trained in the past can generalize to such new circumstances. In the final set of experiments, it was studied how the model performance ages with time in the URL- and cascade-wise settings. These experiments aim to emulate a real-world scenario in which a model trained on historical data is applied to new tweets in real time.

For the URL-wise setting, the dataset was split into training/validation (80% of URLs) and test (20% of URLs) sets; the training/validation and test sets were disjoint and subsequent in time. The results of the model were assessed on subsets of the test set, designed as partially overlapping (mean intersection over union equal to 0.56±0.15) time windows. Partial overlap allowed us to work on larger subsets while preserving the ratio of positives vs negatives, providing at the same time smoother results as with moving average. This way, each window contained at least 24% of the test set (average number of URLs in a window was 73±33.34) and the average dates of two consecutive windows were at least 14 days apart, progressively increasing.

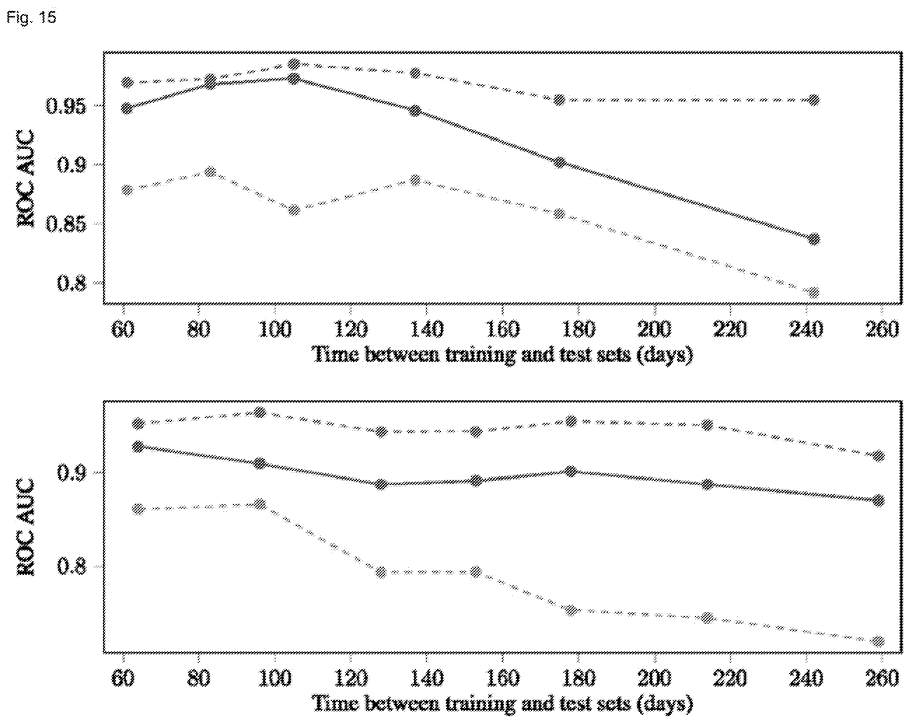

The same experiment was repeated in the cascade-wise setting. The split into training/validation and test sets and the generation of the time windows was done similarly to the URL-wise experiment. Each time window in the test set has an average size of 314±148 cascades, and two consecutive windows had a mean overlap with intersection over union equal to 0.68±0.21. This is shown in FIG. 15 which summarizes the performance of the model in the cascade-wise setting. In this case, it shows a more robust behavior compared to the URL-wise setting, losing only 4% after 260 days.

This different behavior is likely due to the higher variability that characterizes cascades as opposed to URLs. As individual cascades are represented by smaller and simpler graphs, the likelihood of identifying recurrent rich structures between different training samples is lower compared to the URL-wise setting and, also, cascades may more easily involve users coming from different parts of the Twitter social network. In the cascade-wise setting, the propagation-based model is thus forced to learn simpler features that on the one hand are less discriminative (hence the lower overall performance), and on the other hand appear to be more robust to aging. Analysis of this behavior provides additional ways of improving the fake news classification performance.

In the example, a geometric deep learning approach for fake news detection on Twitter social network was presented. The method disclosed allows integrating heterogeneous data pertaining to the user profile and activity, social network structure, news spreading patterns and content. The key advantage of using a deep learning approach as opposed to ‘handcrafted’ features is its ability to automatically learn task-specific features from the data; the choice of geometric deep learning in this case is motivated by the graph-structured nature of the data. The model achieves very high accuracy and robust behavior in several challenging settings involving large-scale real data, pointing to the great potential of geometric deep learning methods for fake news detection.

There are multiple intriguing phenomena. Of particular interest is that the model is potentially language and geography-independent, being mainly based on connectivity and spreading features. The invention is also of great interest with respect to adversarial attacks, both from theoretical and practical viewpoints: on the one hand, adversarial attacks can hardly explore the limitations of the model and its resilience to attacks if any. It can be seen that attacks on graph-based approaches require social network manipulations that are difficult to implement in practice, making the method disclosed particularly appealing. On the other hand, adversarial techniques may shed light on the way the graph neural network makes decisions, contributing to better interpretability of the model. Finally, additional applications of the model in social network data analysis going beyond fake news detection are to be mentioned, such as news topic classification and virality prediction.

Though the aforementioned description and some of the preferred embodiments as well as the example relate to the propagation of news on a single social network, other embodiments of the invention are possible. First, while reference is frequently made to “news”, it will be understood that in the invention, the term “news” or “message” may relate to any information or content spreading on a social network, be it text, image, audio, video, etc or a combination thereof and be it absolutely new or considered to be known for a long time.

In some embodiments of the invention, propagation on multiple social networks may be used to predict the credibility score of the news. In this respect it is noted that the same content is often shared simultaneously on a variety of social networks such as simultaneously in Twitter and Facebook. It is explicitly noted that aggregating information from multiple propagation patterns may be beneficial in evaluating the veracity or other property of a given content or news message.

Furthermore, the invention could be applied to purposes other than take news detection, such as spreading patterns are characteristic of various human behaviors. In one embodiment of the invention, spreading patterns are used to predict the popularity of the content in time (e.g. the number of views, clicks, likes, or retweets/reposts after some time t) sometimes referred to as “virality”. It is specifically emphasized that the spreading patterns could also be used to assign credibility score not only to content but also to users or sources of information.

Though the descriptions of using machine learning for fake news detection refer to a supervised setting, in which a training set of labeled news (“primary dataset”) is provided and one tries to minimize the classification error, such data may be difficult or expensive to obtain. Therefore, in some embodiments of the invention, instead of training the graph neural network on the task of classifying fake news (“primary task”), it is trained on a different task (“proxy task”) for which abundant and inexpensive data is available. For example, one can train a neural network to predict the virality of a tweet (the number of retweets after some time t); the data for such a task does not require any manual annotation. The features learned by such a neural network on the proxy task will also be indicative of the content spreading patterns that are informative for the primary task. Then, the neural network trained on the proxy task can be repurposed for the primary task by a fine-tuning of its parameters or removing parts of its architecture (last layers) and replacing them with new ones suitable for the primary tasks that are trained on the primary data.

1. A method of news evaluation in social media networks having a plurality of socially related users, the method comprising the steps of
determining a social graph at least with respect to users and their social relations;
determining a news message to be evaluated;
determining a propagation behavior of the news message in the social graph;
evaluating the news message in view of its determined propagation behavior in the social graph.

2-43. (canceled)
